(19) United States
(12) Patent Application Publication
(10) Pub. No.: US 2020/0096683 A1
(43) Pub. Date: Mar. 26, 2020

(54) CUBE CORNER RETROREFLECTIVE ARTICLESWITH TAILORED RETROREFLECTIVITY AND METHODS OF MAKING

(71) Applicant: 3M INNOVATIVE PROPERTIES COMPANY, St. Paul, MN (US)

(72) Inventors: Reema Chatterjee, Woodbury, MN (US); Daniel J. Schmidt, Woodbury, MN (US)

(21) Appl. No.: 16/615,979

(22) PCT Filed: May 17, 2018
(86) PCT No.: PCT/US2018/033072

§ 371 Date: Nov. 22, 2019

Related U.S. Application Data
(60) Provisional application No. 62/510,833, filed on May 25, 2017.

(51) Int. Cl. G02B 5/124; G02B 5/08

(52) U.S. Cl. CPC G02B 5/124; G02B 5/0841

(57) ABSTRACT

The present application relates to cube corner retroreflective articles including a conformal coating layer and a sealing layer, and methods of making such articles. In one aspect, the presently described conformal coating layers enable shifting of light to high or low observation and/or high or low entrance angles. In some embodiments, the conformal coating layers include at least one bi-layer.

### TECHNICAL FIELD

The present application relates generally to cube corner retroreflective articles with tailored retroreflectivity and methods of making such retroreflective articles.

### BACKGROUND

Retroreflective articles are characterized by their ability to redirect light to its originating source. Retroreflective articles have found use in a variety of applications, such as in, for example, safety clothing, traffic signs, validation stickers, license plates, and secure documents.

Retroreflective articles (e.g., sheeting) generally include at least one of two types of optical elements: transparent glass or ceramic microspheres (beads), and cube corners (also referred to as prisms or microprisms). Cube corners may be further divided into truncated cube corners and full cube corners (also referred to as preferred geometry (PG) cube corners). The base edges of adjacent cube corner elements of truncated cube corner arrays are typically coplanar. Preferred geometry PG cube corner elements typically comprise at least two non-dihedral edges that are not coplanar. PG cube corners typically exhibit a higher total light return in comparison to truncated cube corner elements. Exemplary beaded retroreflective articles are described in, for example, U.S. Pat. No. 2,407,680 (Palmquist et al.). Exemplary cube corner retroreflective articles are described in, for example, U.S. Pat. No. 5,450,235 (Smith et al.).

Cube corner retroreflective sheeting, sometimes referred to as prismatic sheeting, typically comprises a thin transparent layer having a substantially planar front surface and a rear structured surface comprising a plurality of geometric structures, some or all of which include three reflective faces configured as a cube corner element. In some embodiments, the cube corners are integral with the substantially planar front surface. In these embodiments, the substantially planar front surface is also referred to as land layer. In other embodiments, the substantially planar front surface may be a separate layer from the cube corner elements. In such embodiments, the substantially planar layer may be referred to as body layer.

Some cube corner retroreflective articles may include a sealing layer which enables formation of a low refractive index area (e.g., air gap) between the sealing layer and the cube corner elements. The air gap behind cube corner elements allows light incident on the cube corner element and which encounters active portions of the faces of the cube corner element to be retroreflected. This dielectric face reflectivity is referred to as total internal reflection (TIR). Active portions of cube corner elements depend, for example, on cube corner geometry, cube axis cant and refractive index of the cube corner element material. Advantages of TIR-based retroreflective sheeting include increased daytime brightness and improved appearance of colored articles. Because TIR depends on light encountering active portions of cube corner elements, retroreflectivity for TIR cube corner sheeting is acceptable at small entrance angles but significantly reduced at higher entrance angles. At high entrance angles, light will typically refract (e.g., pass through the face) and be “lost”. Further, other factors impact retroreflectivity of TIR cube corner elements and as a result, not all incident light encountering active portions of the cube corner elements will be totally internally reflected.

Alternatively to TIR-based sheeting, cube corner elements may be adjacent to or coated with a metal coating. In such embodiments the cube corner elements are referred to as metallized cube corner elements. Metallization results in specular retroreflection of light incident on the retroreflective article. Metallization allows the retroreflective sheeting to be protected along the back surface, preventing dirt and moisture from penetrating the construction. It also provides additional strength to the overall article. Disadvantages of metallized constructions include gray appearance of the retroreflective.

Metallized cube corner sheetings have lower overall retroreflectivity than sealed sheetings. Unlike TIR, for which reflectance is 100%, aluminum has a reflectance of only about 85%. Despite lower total light return, metallized sheetings typically perform better under nighttime conditions than sealed (TIR) cube corner sheetings considering all incidence and orientation angles.

As previously discussed, presently-known forms of metallized cube corner sheeting perform poorly under daytime conditions. This is a major shortcoming, as transportation regulations in the United States, Europe, China and Brazil require such retroreflective sheeting to have a minimal daytime luminance factor (cap-Y), as measured by a 0/45 or 45/0 colorimeter. The daytime luminance of an object is described in terms of the second of the tristimulus coordinates (X, Y, Z) for the object, and thus is referred to as “cap-Y”. The cap-Y scale ranges from 0 for a perfectly black object to 100 for a perfectly white object. Whiteness of the sheeting is sometimes described in terms of cap-Y and when measured for a white sheeting, cap-Y effectively measures how white the sheeting is. In contrast to non-metallized, sealed cube corner sheeting, metallized sheeting can appear relatively dark (gray) under daytime conditions, and have a lower cap-Y.

Modifications to cube corner sheeting to overcome the above-mentioned deficiencies have been described in, for example, U.S. Pat. No. 6,325,515 (Coderre et al.) which describes metallized cube corner sheet materials having white marks printed over some fraction of the surface to increase daytime luminance. U.S. Pat. No. 5,840,406 (Nilsen) describes forming white spaces between prisms, which enhance daytime luminance but degrade nighttime performance (retroreflectivity). U.S. Pat. No. 5,376,431 (Rowland) describes a retroreflective microprism sheeting with silver/copper reflecting coating. Even though the retroreflective sheeting employs metallic coatings, it is described as having bright white appearance in daylight as well as a bright white coloration at night. U.S. Pat. No. 5,272,562 (Coderre et al.) describes cube corner sheeting with pigment particles dispersed therein to improve daytime luminance. U.S. Pat. No. 4,801,193 (Martin) describes a method of removing a predominant portion of the metallic coating from the back side of the cube-corner elements. A metallic coating in the form of a grid results, with lighter areas between the grid lines. U.S. Pat. No. 5,854,709 (Couzin) describes chameleonic cube corners wherein the mode of reflection at each cube face can shift from dielectric to metallic. These chameleonic cube corners comprise a first transparent layer including cube corner elements and having a high refractive index, a second thin transparent layer in substantially uninterrupted contact with the cube corner elements and having a refractive index lower than the refractive index of the first layer, and a third reflective metallic layer in substantially uninterrupted contact with the second layer. U.S. Pat. No. 7,922,344 (Chapman et al.) describes a retroreflective sheeting having a metallic layer and comprising diffusing patches to scatter incoming light thereby increasing daytime brightness to a desired level.

Alternatively, and in lieu of metallic coatings or sealing layers, dielectric mirrors may be used, such as described, for example, in U.S. Pat. No. 3,700,305 (Bingham) which describes beaded retroreflective sheetings comprising dielectric mirrors. U.S. Pat. No. 6,172,810 (Fleming et al.) describes retroreflective articles that have a multilayer reflective coating that includes multiple polymer layers disposed in optical association with a layer of optical elements, wherein the overall multilayer reflective coating reflects light in a desired wavelength range. PCT Publication No. WO 2016/039820 (McCoy et al.) describes exposed lens retroreflective articles comprising a self-assembled dielectric mirror.

### SUMMARY

Despite previous efforts, there continues to be a need to provide cube corner article with tailored retroreflectivity profiles while having adequate daytime luminance.

In one aspect, the present inventors sought to control retroreflectance (R_{T} and R_{A}) of cube corner article without resorting to changing the geometry of cube corner elements. In one aspect, the present inventors developed non-metallized cube corner retroreflective articles and methods of making, wherein the retroreflective articles exhibit tailored retroreflectivity profiles while maintaining adequate daytime luminance (cap-Y).

In another aspect, the present inventors sought to develop retroreflective articles with increase in retroreflectivity at specific conditions when compared to conventional sealed (e.g., TIR) retroreflective articles having the same cube corner geometry. In one aspect, the present inventors sought to increase total light return of non-metallized retroreflective article across multiple entrance angles and/or observation angles when compared to conventional sealed retroreflective articles while maintaining adequate daytime luminance. In yet another aspect, the present inventors developed non-metallized cube corner article with increased retroreflectivity at low entrance and/or observation angles when compared to conventional sealed retroreflective articles. In yet another aspect, the present inventors developed non-metallized cube corner retroreflective articles having increased retroreflectivity at high entrance angles when compared to conventional sealed cube corner articles having the same cube corner geometry. In yet another aspect, the present inventors developed non-metallized cube corner retroreflective articles having increased retroreflectivity when compared to conventional sealed cube corner articles and closer to that of metallized cube corner articles and the daytime luminance (cap-Y) of the sheeting closer to conventional sealed cube corner articles.

Exemplary embodiments of the present application are included below.

In some embodiments, the present application relates to a retroreflective article comprising a retroreflective layer including a plurality of cube corner elements that collectively form a structured surface that is opposite a major surface; a conformal coating layer adjacent to the structured surface; a sealing layer adjacent to the conformal coating layer; and a low refractive index layer between the sealing layer and the conformal coating layer.

In some embodiments, the conformal coating layer includes a stack comprising at least one bi-layer. In some embodiments, the bi-layer includes a first material and a second material. In some embodiments, the first material includes a first bonding group and the second material includes a second bonding group. In some embodiments, at least one of the first material or the second material includes a polyelectrolyte. In some embodiments, the first material includes a polyelectrolyte and the second material includes nanoparticles. In some embodiments, the first material includes a polycation and the second material includes a polyanion. In some embodiments, polycation is selected from the group consisting of polydiallydimethylammonium chloride, polyethyleneimine, or polyallylamine, poly(2-(trimethylamino)ethyl methacrylate, and copolymers thereof. In some embodiments, one of the first material or the second material includes metal oxide nanoparticles selected from the group consisting of silica, zirconia, and titania. In some embodiments, one of the first material or the second material includes elements selected from the group consisting of zirconium, silicon and titanium. In some embodiments, the cube corner elements have a first refractive index and the conformal coating layer has a second refractive index, wherein the second refractive index is greater than the first refractive index. In some embodiments, the conformal coating layer has a refractive index between about 1.6 and about 2.4. In some embodiments, the refractive index is between 1.6 and 1.9. In some embodiments, the conformal coating layer has a thickness between about 10 nm and about 250 nm. In some embodiments, the thickness is between about 50 nm and about 150 nm. In some embodiments, the first material contacts the cube corner elements. In some embodiments, the conformal coating layer includes a dielectric mirror. In some embodiments, the sealing layer further includes a first region in contact with the conformal coating layer and a second region, and wherein the first region surrounds the second region. In some embodiments, the second region of the sealing layer includes at least one barrier layer. In some embodiments, the low refractive index layer includes one of a low refractive index material and air. In some embodiments, the sealing layer comprises one of a pressure sensitive adhesive or a hot-melt adhesive. In some embodiments, the first region of the sealing layer is raised relative to the second region. In some embodiments, the second region corresponds to a cell having a cell size. In some embodiments, the cell size is less than 1000 microns.

In some embodiments, the present application relates to a retroreflective article comprising: a retroreflective layer including a plurality of cube corner elements that collectively form a structured surface that is opposite a major surface; a conformal coating layer adjacent to the structured surface, the conformal coating layer comprising at least one bi-layer, wherein the bi-layer includes a first layer in planar contact with at least a portion of the structured surface and a second layer adjacent the first layer; a sealing layer having a first region and a second region, wherein the first region is in contact with a portion of the first layer of the conformal coating layer and surrounds the second region; and a low refractive index layer between the second region and the structured surface. In some embodiments, the first layer is an organic layer and the second layer is an inorganic layer.

In some embodiments, the retroreflective articles of the present application have a cap-Y equal to or greater than 40. In some embodiments, the retroreflective articles of the present application exhibit retroreflectivity at an observation angle of 0.2 degree, orientation angle of 0 and entrance angle of 4 degrees of at least 180 cd/lux·m². In some embodiments, the retroreflective articles of the present application have a peak in a fractional retroreflectance (R_{T} slope) slope curve that is less than 0.8 degree. In other embodiments, the retroreflective articles of the present application have a peak in a fractional retroreflectance (R_{T} slope) slope curve that is greater than 0.8 degree.

In some embodiments, the present application relates to a method of making a retrorereflective article comprising: providing a retroreflective layer including a plurality of cube corner elements that collectively form a structured surface opposite a major surface; forming a conformal coating layer by applying a first layer having a first bonding group to the structured surface, and applying a second layer having a second bonding group to the first layer; providing a sealing layer; and forming a low refractive index layer between the sealing layer and the conformal coating layer. In some embodiments, at least one of the first layer or the second is applied by layer-by-layer self-assembly.

### BRIEF DESCRIPTION OF THE DRAWINGS

FIG. 1 is a cross-sectional side view of an exemplary embodiment of a retroreflective article according to the present application.

FIG. 2 is a close-up view of the retroreflective article of FIG. 1, taken of the portion enclosed in the circle labeled “2” in FIG. 1.

FIG. 3 is a cross-sectional side view of another exemplary embodiment of a retroreflective article according to the present application.

FIG. 4 is a cross-sectional side view of another exemplary embodiment of a retroreflective article according to the present application.

FIGS. 5a and 5b are graphs showing, respectively, the % Rt and % Rt Slope of, respectively, Examples 1-4 and Comparative Examples A-B.

FIGS. 6a and 6b are graphs showing, respectively, the % Rt and % Rt Slope of, respectively, Examples 5-7 and Comparative Examples A-B.

The figures are not necessarily to scale. Like numbers used in the figures refer to like components. However, it will be understood that the use of a number to refer to a component in a given figure is not intended to limit the component in another figure labeled with the same number.

In the following detailed description, reference may be made to the accompanying drawing that forms a part hereof and in which is shown by way of illustration one exemplary specific embodiment. It is to be understood that other embodiments are contemplated and may be made without departing from the scope or spirit of the present disclosure.

### DETAILED DESCRIPTION

Various embodiments and implementations will be described in detail. These embodiments should not be construed as limiting the scope of the present disclosure in any manner, and changes and modifications may be made without departing from the spirit and scope of the inventions. Further, only some end uses have been discussed herein, but end uses not specifically described herein are included within the scope of the present disclosure. As such, the scope of the present disclosure should be determined only by the claims.

The term “entrance angularity” is commonly used to describe the retroreflective performance of retroreflective articles as a function of the entrance angle of light incident on the article and the orientation of the article. The entrance angle of incident light is typically measured with respect to an axis that extends normal to the base surface of the article. The retroreflective performance of an article may be expressed as a percentage of the total light incident on the face of the article which is returned by the article at a particular entrance angle (total light return, TLR).

The term “observation angularity” is commonly used to describe the retroreflective performance of retroreflective articles as a function of varying observation angles and the orientation of the article.

The term “conformal” as used herein means that a material or layer follows the contour, or matches the shape of an adjacent surface. In other words, a conformal coating layer adjacent a structured surface, for example, will have a substantially identical shape to the structured surface.

The term “coating” as used herein is meant to encompass both a liquid coating and/or a layer formed by application of the coating. It will be clear to the skilled artisan in the context of the present application when the term “coating” refers to the liquid coating and when it refers to the formed layer. In some instances, the formed layer will be expressly described as “coating layer”.

The term “surrounds” as used herein refers to the manner in which a first material is disposed completely around (i.e., encloses on all sides) a second material in at least one reference plane.

The terms “bi-layer” or “bilayer” as used herein refer to a thin film comprising a first layer of a first material and a second layer of a second material. As described herein, in some embodiments the first layer is adjacent and in contact with the second layer. In some embodiments, the first layer is in substantially uninterrupted contact with the second layer. In some embodiments, the bi-layers and stacks of the conformal coating layer are positioned in planar contact with one another.

The phrase “in planar contact” or “planarly contacting” is used to indicate that one layer or layered structure is contacting (and disposed either above or below) another layer or layered structure. Such contact is facial contact, rather than edge contact. In some embodiments, the first material is a polycation and the second material is a polyanion. In some embodiments, at least one of the polycation or the polyanion include an inorganic component. In some embodiments, the polyanion includes at least one metal oxide.

The term “stack” as used herein refers to the thickness of material comprising one or more bi-layers.

The terms “high refractive index” and “low refractive index” are relative terms and used when two layers are compared in both in-plane directions of interest. The layer that has greater in-plane average refractive index is the high refractive index layer, whereas the layer that has lower in-plane average refractive index is the low refractive index layer.

The terms “high entrance angle” and “low entrance angle” are relative terms. In some embodiments, high entrance angles are angles equal to or greater than about 30 degrees (e.g., 40, 50, 60 degrees). In some embodiments, low entrance angles are angles lower than 30 degrees (e.g., 25, 20, 15, 4, 2 degrees).

The terms “high observation angle” and “low observation angle” are relative terms. In some embodiments, high observation angles are angles equal to or greater than about 1 degree (e.g., 1, 2, 4 degrees). In some embodiments, low observation angles are angles lower than 1 degree (e.g., 0.8, 0.5, 0.2 degree).

It is generally known in the art that entrance angularity of a cube corner retroreflective sheeting can be altered by, for example, canting some or all of the cube corner elements, as described in U.S. Pat. No. 5,565,151 (Nilsen) and U.S. Pat. No. 4,588,258 (Hoopman). Canting of PG cube corner elements is described in U.S. Pat. No. 6,015,214 (Heenan et al.).

The present inventors sought to tailor retroreflectance or the retroreflectivity profile of retroreflective articles comprising cube corner elements, thereby shifting light to high or low observation and/or high or low entrance angles, without imparting changes to the cube corner elements themselves.

In one aspect, the present inventors sought to alter entrance angularity of a cube corner retroreflective article without having to modify the cube corner elements. In one embodiment, the present inventors developed non-metallized cube corner retroreflective articles including a conformal coating layer and sealing layer and having increased retroreflectivity at low entrance angles (e.g., 4 degrees, 15 degrees) when compared to retroreflective articles having effectively the same cube corner element geometry in a conventional TIR construction (i.e., using non-metallic materials such as, for example, a sealing layer). In another embodiments, the present inventors developed non-metallized cube corner retroreflective articles including a conformal coating layer and sealing layer and having increased retroreflectivity at high entrance angles (e.g., 30 degrees, 60 degrees) when compared to retroreflective articles having effectively the same cube corner element geometry in a conventional TIR construction (e.g., having a sealing layer). In some embodiments, the cube corner retroreflective articles of the present application maintain adequate daytime luminance (cap-Y).

In another aspect, the present inventors sought to alter observation angularity of a cube corner retroreflective article. In one embodiment, the present inventors developed non-metallized cube corner retroreflective articles including a conformal coating layer and a sealing layer and having increased retroreflectivity at low observation angles (e.g., at 0.2 degree) when compared to retroreflective articles having effectively the same cube corner element geometry but in a conventional TIR construction (e.g., using conventional non-metallic materials such as, for example, sealing layer).

In yet another aspect, the present inventors sought to alter the retroreflectivity profile of a cube corner retroreflective article. In one embodiment, the present inventors developed cube corner retroreflective articles including a conformal coating layer and having increased total light return over a plurality of observation angles when compared to retroreflective articles having effectively the same cube corner element geometry but using convention non-metallic materials (e.g., sealing layer).

The present disclosure generally relates to retroreflective articles comprising a conformal coating layer and a sealing layer. In some embodiments, the conformal coating layer is a self-assembled dielectric mirror. In some embodiments, the conformal coating layer can be self-assembled by employing bi-layers, each bi-layer comprising a first layer of a first material with a first bonding group and a second layer of a second material with a second bonding group. In some embodiments, the conformal coating layer can include a polyelectrolyte. That is, in some embodiments, the first bonding group can be a first (poly)electrostatic charge (e.g., a (poly)cation), and the second bonding group can be a second (poly)electrostatic charge (e.g., a (poly)anion) that is attracted to, and opposite that of, the first (poly)electrostatic charge. For example, in some embodiments, the first material can include a polycationic material, and the second material can include a polyanionic material.

In one aspect, the present retroreflective articles include a conformal coating layer and a sealing layer. In some embodiments, the conformal coating layer may include dielectric mirrors. While dielectric mirrors in retroreflective articles have been previously described (see U.S. Pat. No. 6,172,810 (Fleming et al.), WO 2016/039820 (McCoy et al.)), such mirrors were used to enable retroreflection and as alternatives to conventional sealing layers and/or metal layers. Further, Fleming et al. discourages the use of inorganic dielectric mirrors which could “be susceptible to air or moisture-induced corrosion that can degrade reflectivity and/or lead to delamination of layers”.

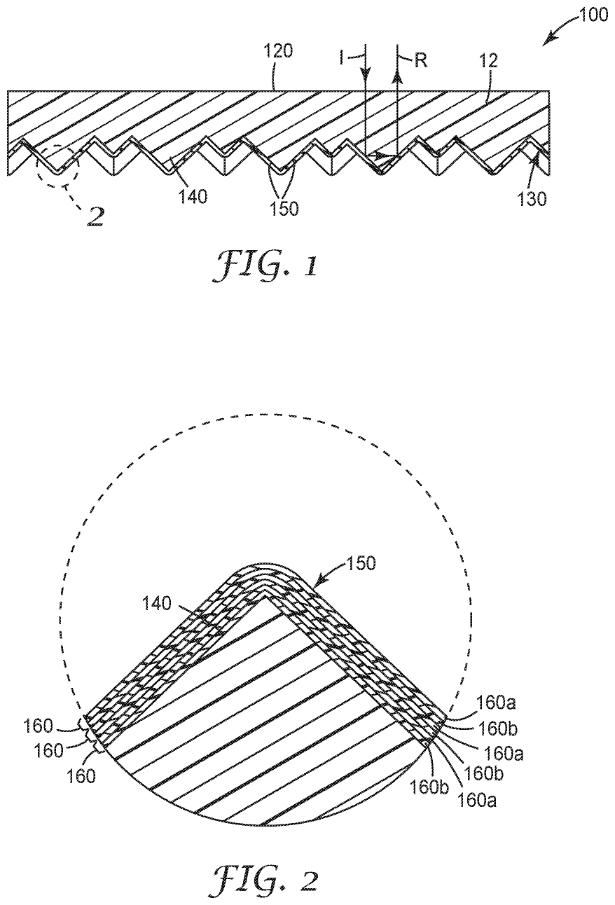

FIG. 1 is a cross-sectional side view of an exemplary retroreflective article 100 according to the present application. The retroreflective article 100 has a first major surface 120 and a second major surface 130, opposite the first major surface 120. In some embodiments, the first major surface 120 is generally flat and is designated as the front surface of the article. The second major surface 130 is structured and comprises a plurality of cube corner elements 140. Conformal coating layer 150 is adjacent cube corner elements 140. In some embodiments, an intervening element may be present between conformal coating layer 150 and cube corner elements 140. In some embodiments, the intervening element may include a surface treatment such as a corona treatment or a primer.

FIG. 2 is a close-up view of the retroreflective article of FIG. 1, taken of the portion enclosed in the circle labeled “2” in FIG. 1. Conformal coating layer 150 follows the contour of cube corner elements 140 and includes a stack of three bi-layers 160. Each bi-layer 160 includes a first layer 160a and a second layer 160b. In some embodiments, the first layer 160a comprises a material having a first bonding group (e.g., a polycation) and the second layer 160b comprises a material having a second bonding group (e.g., a polyanion). While the conformal coating layer 150 shown in FIG. 1 depicts three bi-layers 160 for simplicity, it is within the scope of the present application to provide conformal coating layers having a plurality of bi-layers. In some embodiments, conformal coating layers according to the present application include 5, 10, 15, 20, up to 100 bi-layers.

In some embodiments, conformal coating layers 150 include a stack of bi-layers having the same composition. That is, the first layer 160a and second layer 160b of a first bi-layer 160 has the same composition as, respectively, the first layer 160a and second layer 160b of a second bi-layer 160. In other embodiments, the stack comprises bi-layers having different compositions. In these embodiments, the first layer 160a and second layer 160b of a first bi-layer 160 differ in composition from, respectively, the first layer 160a and second layer 160b of a second bi-layer 160. In some embodiments, the first bi-layer may have a high refractive index and the second bi-layer may have a low refractive index. In some embodiments, the stack may comprise alternating bi-layers of high refractive index and low refractive index. In yet another embodiment, the stack may comprise alternating bi-layers in a “block” configuration such as, for example, high refractive index bi-layer/high refractive index bi-layer/low refractive index bi-layer/low refractive index bi-layer. By “block configuration” it is meant that at least two bi-layers having the same construction are immediately adjacent. It should be apparent to the skilled artisan that the stack may comprise more than four alternating bi-layers.

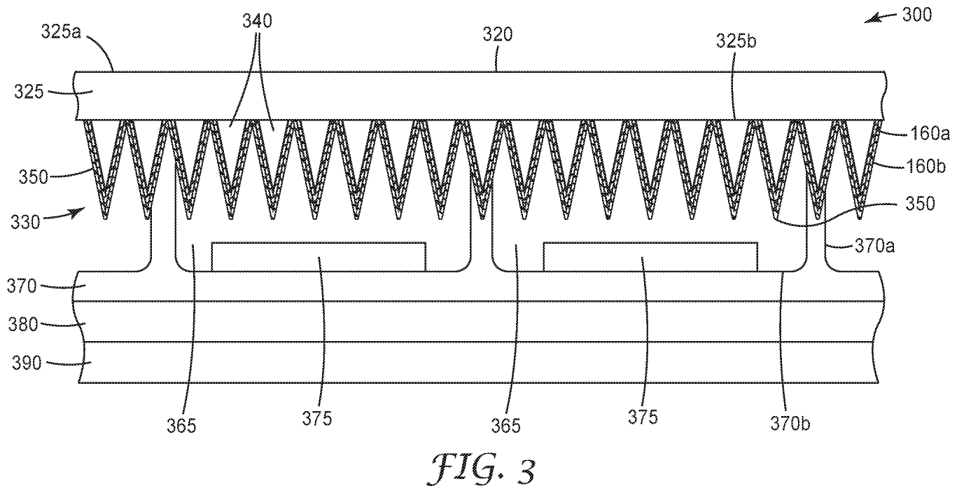

FIG. 3 is a cross-sectional side view of a second exemplary retroreflective article 300 according to the present application. The retroreflective article 300 has a first major surface 320 and a second major surface 330, opposite the first major surface 320. The first major surface 320 comprises a body layer 325 having a first side 325a and a second side 325b. The second major surface 330 is structured and comprises a plurality of cube corner elements 340 disposed on the second side of the body layer 325b. Conformal coating layer 350 is disposed on at least some of cube corner elements 340 and comprises a plurality of bi-layers. Each bi-layer further comprises a first layer 160a and a second layer 160b. A sealing layer 370 having a first region 370a and a second region 370b is also shown. The first region 370a is raised relative to the second region 370b, and the first region 370a contacts at least a portion of conformal coating layer 350. Sealing layer 370 enables formation of a low refractive index area 365 (e.g., air gap). In some embodiments, sealing layer 370 may further comprise barrier elements 375. In other embodiments, sealing layer 370 does not include barrier elements (not shown). While sealing layer 370 is shown as a unitary construction, a multi-layer sealing layer may also be used and is within the scope of the present application. Retroreflective article 300 further includes an adhesive layer 380 and a release layer 390.

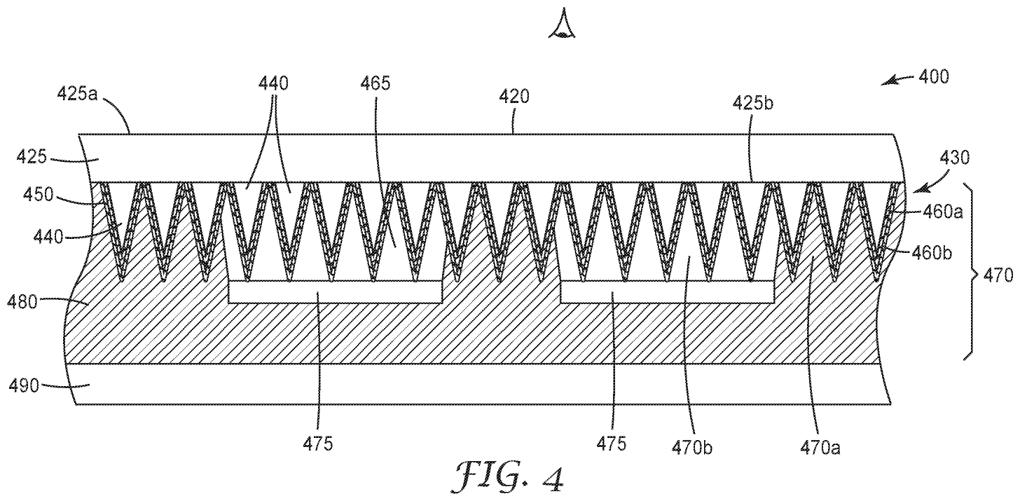

FIG. 4 is a cross-sectional side view of a third exemplary retroreflective article 400 according to the present application. The retroreflective article 400 has a first major surface 420 and a second major surface 430, opposite the first major surface 420. The first major surface 420 comprises a body layer 425 having a first side 425a and a second side 425b. The second major surface 430 is structured and comprises a plurality of cube corner elements 440 disposed on the second side of the body layer 425b. Conformal coating layer 450 is disposed on cube corner elements 440 and comprises at least one bi-layer having a first layer 460a and a second layer 460b. Sealing layer 470 enables formation of a low refractive index area 465 and includes a first region 470a and a second region 470b. The first region 470a contacts at least a portion of conformal coating layer 450 and in some embodiments, the first region 470a includes an adhesive 480. In some embodiments, the adhesive 480 is one of a pressure-sensitive adhesive and a hot-melt adhesive. The second region 470b includes a low refractive index layer (e.g., air gap) and barrier elements 475. Retroreflective article 400 further includes a release liner 490 adjacent adhesive 480.

In some embodiments, conformal coating layers used in the retroreflective articles of the present application include alternating bi-layers or stacks of high RI and low RI. By alternating stacks of bi-layers with different refractive indexes (RIs)—e.g., a “high” RI and a “low” RI, phased reflections are produced at the interfaces, selectively reinforcing certain wavelengths (constructive interference) and cancelling other wavelengths (destructive interference). By selecting certain variables such as stack thickness, refractive indices, and number of the stacks, as explained in more detail below, the band(s) of reflected and/or transmitted wavelengths can be tuned and made as wide or as narrow as desired.

In some embodiments, the thickness of each bi-layer within a stack may differ from each other. In other embodiments, the thickness of the first layer in a bi-layer is different from the thickness of the second layer.

In some embodiments, the bi-layers may include materials having electrostatic interactions (e.g., first and second materials comprising at least one of a polycation and a polyanion). However, other complementary binding interactions can include, but are not limited to, hydrogen bonding, Van der Waals interactions, hydrophobic interactions, metal ions/ligands, covalent bonding moieties, and/or substrate-ligand binding. Additional details and specific examples of some of these types of complementary binding interactions can be found in E. Seyrek, G. Decher, “Layer-by-Layer Assembly of Multifunctional Hybrid Materials and Nanoscale Devices,” Polymer Science: A Comprehensive Reference, 2012, Vol. 7.09, p. 159-185, which is incorporated herein by reference.

By way of example, bi-layers may include at least one inorganic material and a polymeric material. In some embodiments, the inorganic materials are inorganic nanomaterials (or inorganic nanoparticles). In some embodiments, the inorganic materials include at least one metal oxide. The polymeric material (a polyelectrolyte) has complementary binding to the inorganic nanomaterial. The materials having the first bonding group and the complementary second bonding group include polyanionic material and polycationic material in some examples and hydrogen bond donor material and hydrogen bond acceptor material in other examples. Polymers, nanoparticles, and small molecules can be referred to as “polyionic” or “polyion” or, specifically, “polyanionic”, “polyanion”, “polycation” or “polycationic,” if they contain a plurality of negative or positive ionic charged sites, respectively. Examples of polyelectrolytes and inorganic nanoparticles are described in greater detail below.

In some embodiments, a plurality of bi-layers can form one of a low or high refractive index stack. In some embodiments, conformal coating layer includes solely a low refractive index stack. In other embodiments, conformal coating layer includes solely a high refractive index stack. In yet other embodiments, conformal coating layer includes a low refractive index stack alternated with a high refractive index stack, until desired, to achieve the desired reflectivity over the desired band of wavelengths.

The conformal coating layer can be tuned to reflect selected bands of wavelengths, while transmitting other selected bands of wavelengths. The conformal coating layers of the present disclosure generally use the principle of thin-film interference to reflect specific wavelengths of electromagnetic (EM) radiation. For example, when light strikes the conformal coating layers at an angle, some of the light is reflected from the top (or front) surface of a stack, and some of the light is reflected from the bottom (or rear) surface where the stack is in contact with an underlying stack. Because the light reflected from the bottom travels a slightly longer path, some light wavelengths are reinforced by this delay, while others tend to be canceled, producing the observed filtering/reflecting effect.

In some embodiments, the thickness of a bi-layer, the number of bi-layers per stack, the number of stacks, and the thickness of each stack are selected to achieve the desired optical properties using the minimum total thickness of self-assembled layers and/or the minimum number of layer-by-layer deposition steps. In some embodiments, the thickness of each bi-layer can range from about 1 nm to about 100 nm. For example, in some embodiments, the thickness of each bi-layer can be at least about 5 nm, in some embodiments, at least about 10 nm, in some embodiments, at least about 15 nm, and in some embodiments, at least about 20 nm. In some embodiments, the thickness of each bi-layer can be no greater than about 100 nm, in some embodiments, no greater than about 50 nm, and in some embodiments, no greater than about 20 nm.

In some embodiments, the number of bi-layers per stack can range from about 1 to about 25. For example, in some embodiments, the number of bi-layers can be at least about 2, 3, 4, 5, 6, 7, 8, 9, and at least about 10. In some embodiments, the number of bi-layers can be no greater than about 25, 20, 19, 18, 17, and no greater than about 15.

In some embodiments, as mentioned above, stacks that form the conformal coating layer of the present disclosure comprise bi-layers, and the bi-layers have a polyelectrolyte as one constituent material, and inorganic nanoparticles as another constituent material. As described in more detail below, in some embodiments, bi-layers are prepared via layer-by-layer (LbL) deposition methods, such as spray, dip, or spin LbL deposition.

In some embodiments, the polyelectrolyte is a polycation. In some embodiments, the polycation is a polycationic polymer. Suitable polycationic polymers can include, but are not limited to, polydiallyldimethylammonium chloride (PDAC), linear and branched poly(ethyleneimine) (PEI), poly(allylamine hydrochloride) (PAH), polyvinylamine, chitosan, polyaniline, polyamidoamine, and poly(vinylbenzyltriamethylamine). In some embodiments, the polyelectrolyte is a polyanionic polymer. Suitable polyanionic polymers include, but are not limited to, sulfonated polystyrene (PSS), poly(vinyl sulfate), poly(vinyl sulfonate), poly(acrylic acid), poly(methacrylic acid), dextran sulfate, heparin, hyaluronic acid, carrageenan, carboxymethylcellulose (CMC), alginate, sulfonated tetrafluoroethylene based fluoropolymers such as Nafion®, poly(vinylphosphoric acid), poly(vinylphosphonic acid), and sodium hexametaphosphate.

In some embodiments, the nanoparticles can be one or more of doped and undoped oxides, nitrides or sulfides of metals. For example, such metals include, but are not limited to, silicon, titanium, cerium, zinc, iron, tin, aluminum, zirconium, tungsten, vanadium, niobium or combinations thereof. For example, in some embodiments, the nanoparticles comprise titania (TiO₂), silica (SiO₂), aluminum oxide (Al₂O₃), or the like. In some embodiments, the nanoparticles comprise mixed metal oxides—e.g., the nanoparticles comprise titania and silica, or titania and alumina.

In some embodiments, the nanoparticles comprise a plurality of electrostatic charges. The RIs of adjacent stacks can be made different by selecting different nanoparticles for each stack. In general, the larger the difference in the RIs of the nanoparticles in each stack, the larger the difference in the RIs of the stacks. Processing conditions can also influence the RIs of the stacks.

As mentioned above, it is possible to use hydrogen bonding as the mechanism of LbL coating. In this case, the polymeric material is a hydrogen bond donating polymer (e.g. poly(acrylic acid), poly(methacrylic acid), polyvinyl alcohol) or a hydrogen bond accepting polymer (e.g. polyethyleneoxide, polyvinylpyrrolidone). A hydrogen bond is a relatively weak secondary interaction between a hydrogen atom bound to a more electronegative atom and another atom that is also generally more electronegative than hydrogen and has one or more lone electron pairs, enabling it to act as a base.

Hydrogen bond donors are moieties that contain at least one hydrogen atom that may participate in hydrogen bond formation, and a more electronegative atom bound to the hydrogen atom. Examples of these moieties include, preferably, O—H and N—H, and less preferably, P—H, S—H. The moiety C—H may also, less preferably, be a hydrogen bond donor, when the carbon atom is bound to another atom through a triple bond, when the carbon atom is bound through a double bond to O, or when the carbon atom is bound to at least two atoms selected from O, F, Cl and Br. Hydrogen bond acceptors are moieties that contain an atom more electronegative than hydrogen that also has a lone pair of electrons. Examples of these atoms include preferably N, O and F, and less preferably Cl, Br, I, S and P. Examples of hydrogen bond acceptor moieties include C═O, O—H, N—H, C—F, P═O and C≡N.

Useful LbL material utilizing hydrogen bonding include polymers containing hydrogen bond donors and/or hydrogen bond acceptors, for example polycarboxylic acids such polyacrylic acid and polymethacrylic acid; polynucleotides such as poly(adenylic acid), poly(uridylic acid), poly(cytidylic acid), poly(uridylic acid) and poly(inosinic acid); polymers of vinyl nucleic acids such as poly(vinyladenine); polyamino acids such as polyglutamic acid and poly(ε-N-carbobenzoxy-L-lysine); polyalcohols such as poly(vinyl alcohol); polyethers such as poly(ethylene oxide), poly(1,2-dimethoxyethylene), poly(vinylmethyl ether), and poly(vinylbenzo-18-crown-6); polyketones and polyaldehydes such as poly vinyl butyral and poly(N-vinyl-2-pyrrolidone); polyacrylamides such as polyacrylamide, polymethacrylamide and poly(N-isopropylacrylamide); polyamines such as poly(-amine)styrene; polyesters such poly(cyclohexane-1,4-dimethylene terephthalate) and polyhydroxy methyl acrylate; polyphosphazenes such as poly(bis(methylamino)phosphazene) and poly(bis(methoxyethoxyethoxy)phosphazene; polysaccharides such as carboxymethyl cellulose; and copolymers thereof.

In some embodiments, the conformal coating layer of the present disclosure can include porous polymer-containing stacks. In some such embodiments, the porous stacks comprise air within the pores, and are readily adaptable to different stresses (e.g., temperature) as the polymer and air imparts ductility into the thin film. In some embodiments, the presence of a certain amount of porosity within the films making up a conformal coating layer can provide more surface area, e.g., to provide strong adhesion between the conformal coating layer and the cube corner elements (or an intermediate layer located therebetween). For example, in some embodiments, at least some of the stacks making up the conformal coating layer can have a porosity of at least 1%, at least 5%, at least 15%, at least 20%, at least 25%, at least 30%, at least 40%, and in some embodiments, at least 50% (represented as volume percents, vol %).

Conformal coating layers can be designed to reflect specific wavelengths of incident EM energy. For example, a conformal coating layer can be built to specifically reflect a band of wavelengths (λ1-λ2), including a peak reflectance at λ3, which is within the range of (λ1-λ2), and may or may not be at the center of (λ1-λ2). In some embodiments, λ3 can be a wavelength in the Vis spectrum, from 400 nm to 700 nm. For example, in some embodiments, λ3 can be about 550 nm (e.g., at or near the peak sensitivity within the photopic range).

As described above, the conformal coating layer may comprise alternating first and second stacks. The first stack can have a high RI equal to nH (or n1) and the second stacks can have a low RI equal to nL (or n2), wherein nH is significantly higher (e.g., higher by a value equal to or more than 0.3, 0.4, 0.5, 0.6, 0.7, 0.8, etc.) than nL.

That is, in some embodiments, nH and nL can differ by at least 0.3, in some embodiments by at least 0.4, in some embodiments, by at least by 0.5, in some embodiments, by at least 0.6, in some embodiments by at least 0.7, and in some embodiments, at least 0.8. In some embodiments, nH and nL can differ by no greater than 1.4, in some embodiments, by no greater than 1.2, and in some embodiments, no greater than 1.0.

RIs nH and nL can be made different, by selecting, e.g., different polymers and/or nanoparticles for the first and second materials. In general, the larger the difference in the RIs of the polymers and/or nanoparticles in each stack, the larger is the difference in the RIs of the stacks. Processing conditions can also influence the RIs of the stacks.

Optical thickness is defined as:

t=nd (1)

where n is the refractive index and d is the actual physical thickness of the stack. In some embodiments, the high RI stacks and the low RI stacks have optical thicknesses equal to each other. In some embodiments, they can each have an optical thickness equal to λ¼. In some embodiments, the corresponding physical thickness can be given by λ1/(4*n), wherein n is the respective refractive index at λ1. Such stacks can be referred to as having quarter wavelength optical thicknesses (QWOTs). In some embodiments, the optical thicknesses of the high RI stacks and the low RI stacks are not the same, especially for designs that provide less angular dependence. In some embodiments, the physical thicknesses of the high RI stacks and the low RI stacks are not the same.

In some embodiments, the physical thickness of the high RI stack can be at least 20 nm, at least 40 nm, or at least 60 nm. In some embodiments, the physical thickness of the high RI stack can be no greater than 200 nm, no greater than 150 nm, or no greater than 100 nm. In some embodiments, the high RI stack can be 70 nm.

In some embodiments, the physical thickness of the low RI stack can be at least 30 nm, at least 60 nm, or at least 90 nm. In some embodiments, the physical thickness of the low RI stack can be no greater than 250 nm, no greater than 200 nm, or no greater than 150 nm. In some embodiments, the low RI stack can be 110 nm.

In some embodiments the conformal coating layer can include a plurality of stacks (i.e., the high RI stacks (“H”) and the low RI stacks (“L”)) arranged in a repetitive sequence such as HLHLH or LHLH. In some embodiments the conformal coating layer can include an odd number of stacks. For example, in some arrangements, the conformal coating layer can include 1, 3, 5, 7, 9, or 11 stacks, or more than 11 stacks. In some embodiments the conformal coating layer can include an even number of stacks. For example, in some embodiments, the conformal coating layer can include 2, 4, 6, 8 10, or 12, or more than 12 stacks.

In some embodiments, the conformal coating layer can include at least 1, 2, 3, 4, 5, 6, 7, 8, 9, 10, 11, 12, 13, 14, 15, 16, 17, 18, 19, or at least 20 stacks. In some embodiments, better reflection is obtained with a relatively small number of stacks (e.g., 1 stack, 2 stacks, 3 stacks).

In some embodiments, the number of stacks is less than a specified amount, such as less than 25, less than 20, less than 15, or less than 10 stacks. In some embodiments, the number of stacks is optimized to provide for a desired level of reflection and/or optimized with respect to the number of processing steps and cost or complexity of production.

The refractive indices of the various stacks can vary depending on the desired optics of the conformal coating layer. For example, the RI of one or more stacks can be equal to or greater than 1.1, 1.2, 1.3, 1.4, 1.5, 1.6, 1.7, 1.8, 1.9, 2.0, 2.1, 2.2, 2.3, or 2.4. In some embodiments the RI of one or more stacks is less than or equal to 2.5, 2.4, 2.3, 2.2, 2.1, 2.0, 1.9, 1.8, 1.7, 1.6, 1.5, 1.4, 1.3, or 1.2. In some embodiments, the “high” RI (i.e., for the high RI stack) is greater than or equal to 1.5, 1.6, 1.7, 1.8, 1.9, 2.0, 2.1, 2.2, 2.3, or 2.4. In some embodiments, the “low” RI (i.e., for the low RI stack) is less than or equal to 2.0, 1.9, 1.8, 1.7, 1.6, 1.5, 1.4, 1.3, or 1.2. In some embodiments, the value of the “high” RI and the value of the “low” RI differ by at least 0.3, or at least 0.4, or at least 0.5, or at least 0.6, or at least 0.7, or at least 0.8. In some embodiments, a greater difference or contrast in RI between the high RI stack and the low RI stack can be advantageous. In some embodiments, the “high” RI is between 1.5 and 2.5, and the “low” RI is between 1.2 and 2.0. It will be appreciated, however, that the “high” RI is always greater than the “low” RI.

The plurality of layers making up the conformal coating layer and deposited by layer-by-layer self-assembly comprises at least two layers applied by what is commonly referred to as a “layer-by-layer self-assembly process.” The resulting conformal coating layer can then be described as a self-assembled dielectric mirror or self-assembled conformal coating layer. This process can be used to assemble thin films or coatings of oppositely charged polyelectrolytes electrostatically, but other functionalities such as hydrogen bonding, Van der Waals interactions, hydrophobic interactions, metal ions/ligands, covalent bonding moieties, and/or substrate-ligand binding can also be the driving force for film assembly.

This deposition process can include exposing a substrate (i.e., cube corner elements) having an ionic surface charge, to a series of liquid solutions, or baths. This can be accomplished, for example, by immersion of the substrate into liquid baths (also referred to as dip coating), spraying, spin coating, roll coating, inkjet printing, and the like. Exposure to the first polyion (e.g. bath) liquid solution, which has an ionic charge opposite that of the substrate, results in ionically charged species near the substrate surface adsorbing quickly, establishing a concentration gradient, and drawing more polyelectrolyte from the bulk solution to the surface. Further adsorption occurs until a sufficient layer has developed to mask the underlying charge and reverse the net charge of the substrate surface. In order for mass transfer and adsorption to occur, this exposure time can be on the order of seconds to minutes.

The substrate is then removed from the first polyion (e.g. bath) liquid solution, and is then exposed to a series of water rinse baths to remove any physically entangled or loosely bound polyelectrolyte. Following these rinse (e.g. bath) liquid solutions, the substrate is then exposed to a second polyion (e.g. bath) liquid solution, which has a charge opposite that of the first polyion (e.g. bath) liquid solution. Once again, adsorption occurs, since the surface charge of the substrate is opposite that of the second (e.g. bath) liquid solution. Continued exposure to the second polyion (e.g. bath) liquid solution then results in a reversal of the surface charge of the substrate. A subsequent rinsing can be performed to complete the cycle. This sequence of steps is said to build up one layer pair, also referred to herein as a bi-layer of deposition and can be repeated as desired to add further layer pairs to the substrate, where each bi-layer includes a first monolayer having a positive or negative surface charge (i.e., outer surface charge) and an adjacent second monolayer having the opposite surface charge of the first monolayer (i.e., negative or positive, respectively).

Some examples of suitable processes include those described in Krogman et al., U.S. Pat. No. 8,234,998 and Nogueira et al., U.S. Pat. No. 8,313,798. Layer-by layer dip coating can be conducted using a StratoSequence VI (nanoStrata Inc., Tallahassee, Fla.) dip coating robot. Layer-by-layer spray coating can be conducted using a SPALAS™ coating system (Nanotrons Corp., Woburn, Mass.).

The LbL process described above makes us of charge-charge (i.e., ionic or electrostatic) interactions. However, LbL processes can also be employed to build stacks by making use of hydrogen bonding, or other complementary interactions to assemble successive layers into a stack. This can involve the use of solvents to ionize molecules or support hydrogen donation and acceptance in the deposition solutions. In some embodiments, alcohols, glycols, and other organic solvents are used. In some embodiments, water is used. In some embodiments, combinations of solvents are used.

As mentioned above, other complementary binding interactions can include, but are not limited to, hydrogen bonding, Van der Waals interactions, hydrophobic interactions, metal ions/ligands, covalent bonding moieties, and/or substrate-ligand binding.

In some embodiments, LbL deposition is carried out by spray application of at least two deposition solutions. In one deposition solution is contained a polyelectrolyte such as a polymer material dissolved in a solvent. In the other deposition solution is contained nanoparticles dissolved or dispersed in a solvent. Multiple spray applications are made in alternating fashion in order to build up the layers of the stack. Adjacent layers contain opposite charges (or another binding pair such as complementary hydrogen bonding groups) such that the layers bind to each other to create a stable stack. Each pair of layers containing complementary binding materials is referred to herein as a bi-layer, and each stack can include one or more bi-layers.

In some embodiments, conformal coating layer formed using spray LbL are made to be porous.

Depending on the choice of deposition parameters, the porosity can range from about 0%, with essentially no pores, to nearly 75%, where a substantial volume fraction of the stack is open space. The RI of a stack decreases with increased porosity, making it possible to tune the RIs of each stack for desirable properties, such as a maximum difference in refractive indices, by adjusting the porosities of the stacks, as well as by choice of materials (e.g. metal oxide nanoparticles) in the stacks. Thus, using LbL to form stacks for conformal coating layers is especially useful, particularly when a wide difference between the RIs of adjacent stacks is desirable. The larger the RI difference between the stacks, the broader the range of wavelengths that are reflected.

In some embodiments, conformal coating layers of the present disclosure are not prepared from co-extruded polymers. In some embodiments, the conformal coating layers are not prepared from a plurality of neutral (i.e., uncharged, or non-polyelectrolyte) polymers.

In some embodiments, stacks are prepared using the methods described herein that have narrow bandpass characteristics. That is, the stacks allow a narrow band of desired frequencies to pass, while still maintaining high reflectivity. In this context, a “narrow band” is meant a band of wavelengths centered around λ1 and having a width at half maximum of, for example, less than 50 nm, or less than 100 nm, or less than 200 nm, or less than 300 nm, or less than 400 nm, or less than 500 nm.

In some embodiments, layer-by-layer self-assembly can be utilized to deposit alternating polymer-polymer layers and alternating inorganic nanoparticle-inorganic nanoparticle layers. However, in some embodiments, the plurality of layers deposited by layer-by-layer self-assembly comprises a plurality of alternating polymer-inorganic nanoparticle layers.

Strong polyelectrolytes can be used as the polymer of the polymer-inorganic nanoparticle layers. For example, PDAC can provide a strongly positively-charged cationic layer.

The molecular weight of the polyelectrolyte can vary, ranging from about 1,000 g/mole to about 1,000,000 g/mole. In some embodiments, the weight-average molecular weight (Mw) of the positively charged cationic layer (e.g. PDAC) ranges from 100,000 g/mole to 200,000 g/mole.

The inorganic nanoparticles of the alternating polymer-inorganic nanoparticle layers can have an average primary or agglomerate particle size diameter of at least 1, 2, 3, 4, or 5 nanometers, and, in some embodiments, can be no greater than 80, 90 or 100 nanometers. The average particle size of the nanoparticles of the dried self-assembled layers can be measured using transmission electron microscopy or scanning electron microscopy, for example. The average particle size of the nanoparticles in the nanoparticle suspension can be measured using dynamic light scattering, for example. “Agglomerate” refers to a weak association between primary particles which may be held together by charge or polarity and can be broken down into smaller entities. “Primary particle size” refers to the mean diameter of a single (non-aggregate, non-agglomerate) particle. As used herein “aggregate” with respect to particles refers to strongly bonded or fused particles where the resulting external surface area may be significantly smaller than the sum of calculated surface areas of the individual components. The forces holding an aggregate together are strong forces, for example covalent bonds, or those resulting from sintering or complex physical entanglement. Although agglomerated nanoparticles can be broken down into smaller entities such as discrete primary particles such as by application of a surface treatment; the application of a surface treatment to an aggregate simply results in a surface treated aggregate. In some embodiments, a majority of the nanoparticles (i.e. at least 50%) are present as discrete unagglomerated nanoparticles in the coating suspensions. For example, in some embodiments, at least 70%, 80% or 90% of the nanoparticles can be present as discrete unagglomerated nanoparticles.

In some embodiments the nanoparticles (e.g. silica) have a relatively small average particle size. For example, in some embodiments, the average primary or agglomerate particle size can be less than 50 nm, less than 30 nm, less than 25 nm, less than 20 nm, or less than 15 nm. In some embodiments, the nanoparticles can have an average particle size of at least 2 nm, at least 3 nm, at least 5 nm, or at least 10 nm.

The concentration of inorganic nanoparticles can be at least 30 wt.-% of the dried low RI stack, high RI stack, or the totality of self-assembled polymer-nanoparticle layers. In some embodiments, the concentration of inorganic nanoparticles can be no greater than about 80 wt-%, in some embodiments, no greater than about 85 wt-%, in some embodiments no greater than about 90 wt-%, and in some embodiments, no greater than about 95 wt-%. The concentration of inorganic nanoparticles can be determined by methods known in the art, such as thermogravimetric analysis. In some embodiments, the dried low RI stack, high RI stack, or the totality of self-assembled polymer-nanoparticle layers can include at least 50 wt-%, at least 55 wt-%, at least 60 wt-%, at least 65 wt-%, or at least 70 wt.-%, or at least 80 wt.-%, or at least 90 wt.-% of inorganic nanoparticles to provide better mechanical durability and scratch resistance in addition to the reflectivity properties previously described.

In some embodiments, the nanoparticles of the low RI stack have a refractive index of no greater than 1.50, such as silica. Nanoparticles for use in the low RI bi-layer or stack can include silica (although other oxides can be used, such as zirconia, alumina, ceria, tin (stannic) oxide,), or composite nanoparticles such as core-shell nanoparticles. A core-shell nanoparticle can include a core of an oxide (e.g., iron oxide) or metal (e.g., gold or silver) of one type and a shell of silica deposited on the core. Herein, the phrase “silica nanoparticles” refers to nanoparticles that include only silica as well as core-shell nanoparticles with a surface that includes silica. It is appreciated however, that unmodified silica nanoparticles commonly comprise hydroxyl or silanol functional groups on the nanoparticle surface, particularly when the nanoparticles are provided in the form of an aqueous dispersion. Aqueous dispersions of silica nanoparticles can also be ammonium or sodium stabilized. Silica has an isoelectric point at about pH 2 and can thus be used as a polyanion in the layer-by-layer self-assembly process at pH values greater than 2, more preferably at pH values greater than or equal to 3.

Some inorganic silica sols in aqueous media are available commercially. Silica sols in water or water-alcohol solutions are available commercially under such trade names as LUDOX (manufactured by W.R. Grace and Company, Columbia, Md.), NYACOL (available from Nyacol Co., Ashland, Mass.) or NALCO (manufactured by Nalco Chemical Co., Oak Brook, Ill.). Some useful silica sols are NALCO 1115, 2326, 1050, 2327, and 2329 available as silica sols with mean particle sizes of 4 nanometers (nm) to 77 nm. Another useful silica sol is NALCO 1034a available as a silica sol with a mean particle size of 20 nanometers. A useful silica sol is NALCO 2326 available as a silica sol with a mean particle size of 5 nanometers. Additional examples of suitable colloidal silicas are described in U.S. Pat. No. 5,126,394 (Revis et al.).

In some embodiments, the nanoparticles of the layer-by-layer self-assembled high RI bi-layer or stack have a refractive index of greater than 1.60, 1.65, 1.70, 1.75, 1.80, 1.85, 1.90, 1.95, 2.00, 2.05, 2.10, 2.15, 2.20, 2.25, 2.30, 2.35, 2.40, 2.45, 2.50, 2.55, 2.60 such as titania, zirconia, alumina, tin oxides, antimony oxides, ceria, zinc oxide, lanthanum oxide, tantalum oxide, mixed metal oxides thereof, and mixtures thereof. Zirconia sols are available under trade name NYACOL® ZRO2 (available from Nyacol Co., Ashland, Mass.) and Nissan Chemical America Corporation under the trade name NanoUse ZR™. Zirconia nanoparticles can also be prepared such as described in U.S. Patent Application Publication No. 2006/0148950 (Davidson et al.) and U.S. Pat. No. 6,376,590 (Kolb et al.).

In some embodiments, the layer-by-layer self-assembled bi-layer, or stack comprises titania. Various forms of titania can be utilized including anatase, brookite, rutile and amorphous forms. Anatase titania nanoparticles (5-15 nm diameter) are commercially available from U.S. Research Nanomaterials, Houston, Tex. as an aqueous suspension at 15 wt %. Titania sols are also available dispersed in strong acid or base condition from Ishihara Sangyo Kaisha Ltd (Osaka, Japan). Titania sols are also available under product code X500 from Titan PE (Shanghai, China). Titania has an isoelectric point at about pH 4-6 and thus can be used as a polyanion in layer-by-layer self-assembly at pH greater than 6, preferably pH greater than 7, more preferably pH greater than 8, or the polycation in layer-by-layer self-assembly at pH less than 4, more preferably pH less than 3.

In some embodiments, the layer-by-layer self-assembled bi-layer, or stack comprises small molecule, titanium (Ti)-containing salts, such as, for example, titanium (IV) bis(ammonium lactate) dihydroxide (TALH).

Various other organic and inorganic nanoparticle particles can be used for the low refractive index or high refractive index bi-layers or stacks of the self-assembled layers, as known in the art, some of which are described in Kurt et al., U.S. Pat. No. 8,446,666.

The selection of the inorganic materials used in creating the multilayer inorganic layer will depend upon the reflection bandwidth of interest. For example, the plurality of layers deposited by layer-by-layer self-assembly can be a quarter (¼) wave stack (QWOT) wherein control of the spectrum is achieved by controlling the thickness of the high and low refractive index stacks by altering the number of deposited bi-layers and/or altering the conditions during the layer-by-layer self-assembly process such as the pH and ionic strength of the liquid (e.g. bath) solutions. It is appreciated that the plurality of layers deposited by layer-by-layer self-assembly generally does not utilize birefringence for creating a refractive index difference between the low refractive and high refractive index stacks.

The retroreflective articles of FIGS. 3 and 4 include a body layer. The term “body layer” typically refers to a material to which cube corner elements are attached or adjacent. In some embodiments, the body layer has a thickness of between about 20 μm and about 2500 μm. In some embodiments, the body layer has a thickness of between about 20 μm and about 1000 μm. In some embodiments, the body layer is a different material(s) than the discrete truncated cube corner elements. In some embodiments, the body layer includes is one or more light transmitting or transparent polymeric materials. In some embodiments, the body layer may itself include more than one layer. In some embodiments where the body layer includes multiple layers, these layers can include more than one composition, and the composition can vary by layer. In some embodiments, the body layer is integral with the cube corner elements and has the same composition as the cube corner elements as shown in FIG. 1. In these embodiments, the body layer is sometimes referred to as land layer.

Some exemplary body layers are described in, for example, U.S. Pat. No. 7,611,251 (Thakkar et al.), incorporated by reference herein in its entirety. Exemplary materials for use in the body layer include, for example, polyethylene, polypropylene, PET (polyethylene terephthalate), PTFE (polytetrafluoroethylene), PVC (polyvinyl chloride), and nylon. In some embodiments, the body layer includes a polyolefin. In some embodiments, the body layer includes at least 50 weight percent (wt-%) of alkylene units having 2 to 8 carbon atoms (e.g., ethylene and propylene). In some embodiments, the body layer includes a biaxially oriented polymer.

In some embodiments, the body layer includes one or more UV absorbers (also referred to as “UVAs”). UVAs are used in retroreflective articles to, for example, protect films containing optical layers from the harmful radiation of the sun in the solar light spectrum (between about 290 nm and 400 nm). Some exemplary UVA materials are described in, for example, U.S. Pat. No. 5,450,235 (Smith et al.) and PCT Publication No. 2012/135595 (Meitz et al.), both of which are incorporated in their entirety herein.

In some embodiments the cube corner elements in the present disclosure are truncated cube corner elements. In some embodiments, the discrete truncated cube corner elements have a height of between about 1.8 mils and about 2.5 mils. The truncated cube corner elements can include any desired materials, including those described in, for example, U.S. Pat. No. 3,712,706 (Stamm) or U.S. Pat. No. 4,588,258 (Hoopman), both of which are incorporated herein by reference in their entirety. Some exemplary materials for use in the truncated cube corner elements include, for example, thermoplastic polymers or polymerizable resins. Exemplary thermoplastic polymers include polycarbonate. Exemplary polymerizable resins suitable for forming the array of cube corner elements may be blends of photoinitiator and at least one compound bearing an acrylate group. In some embodiments, the resin blend contains a monofunctional, a difunctional, or a polyfunctional compound to ensure formation of a crosslinked polymeric network upon irradiation.

Illustrative examples of resins that are capable of being polymerized by a free radical mechanism that can be used in the embodiments described herein include acrylic-based resins derived from epoxies, polyesters, polyethers, and urethanes, ethylenically unsaturated compounds, isocyanate derivatives having at least one pendant acrylate group, epoxy resins other than acrylated epoxies, and mixtures and combinations thereof. The term “acrylate” is used here to encompass both acrylates and methacrylates. U.S. Pat. No. 4,576,850 (Martens) discloses examples of crosslinked resins that may be used in cube corner element arrays of the present disclosure. Polymerizable resins of the type disclosed in, for example, U.S. Pat. No. 7,611,251 (Thakkar) may be used in cube corner element arrays of the present disclosure.

The truncated cube corner elements can be composite cube corner elements, as described in, for example, PCT Publication No. WO 2012/166460 (Benson et al.), incorporated in its entirety herein. Composite truncated cube corner elements include a first resin in a first region of a cube corner element and a second resin in a second region in that cube corner element. Whichever of the first or second resin is directly adjacent to the polymeric layer can be the same or different than the polymeric layer. The plurality of cube corner elements can also be any other type of cube corner element plurality described in PCT Publication No. WO 2012/166460.

In some embodiments, a separate overlay film is provided on the viewing surface of the retroreflective article (not shown). The overlay film can assist in providing improved (e.g., outdoor) durability or to provide an image receptive surface. Indicative of such outdoor durability is maintaining sufficient brightness specifications such as called out in ASTM D49560-la after extended durations of weathering (e.g., 1 year, 3 years). In some embodiments, the cap-Y whiteness is greater than 15 before and after weathering (e.g., 1 year, 3 years).

One or more sealing layers (also referred to, in the singular, as seal film or sealing film or seal layer) may be used on the retroreflective articles of the present application. The sealing layer(s) can include any of the materials mentioned in, for example, U.S. Pat. No. 4,025,159 (McGrath), U.S. Pat. No. 7,611,251 (Thakkar et al.), and U.S. Patent Application Publication No. 2013/114143 (Thakkar et al.) all of which are incorporated by reference in their entirety. In some embodiments, the sealing layer(s) is structured, as described in, for example, U.S. Patent Application Publication No. 2016/0139306 (Chatterjee et al.), which is incorporated by reference herein in its entirety.

Some embodiments include a plurality of individual seal legs that extend between the discrete truncated cube corner elements and a multilayer sealing layer. In some embodiments, these seal legs form one or more cells. A low refractive index material (e.g., a gas, air, aerogel, or an ultra-low index material described in, for example, U.S. Patent Application Publication No. 2010/0265584 (Coggio et al.)) can be enclosed in each cell. The presence of the low refractive index material creates a refractive index differential between the discrete truncated cube corner elements and the low refractive index material. This permits total internal reflection at the surfaces of the discrete truncated cube corner elements. In embodiments where air is used as the low refractive index material, the interface between the air and the discrete truncated cube corner elements is often referred to as an air interface.

In some embodiments, the sealing layer is a multilayer film that includes the layers described in, for example, PCT Publication WO 2011/091132 (Dennison et al.), the disclosure of which is incorporated herein by reference in its entirety.

In some embodiments, sealing layer further comprise a barrier layer, as described in, for example, in U.S. Patent Application Publication No. 2013/0034682 (Free et al.), incorporated herein by reference in its entirety. In these embodiments, the retroreflective sheeting comprises optically active areas in which incident light is retroreflected by a structured surface including, for example, cube corner elements, and one or more optically inactive areas in which incident light is not substantially retroreflected by the structured surface. The one or more optically active areas include a low refractive index layer or material adjacent to a portion of the structured surface. The one or more optically inactive areas include an adhesive material adjacent to a portion of the structured surface. The adhesive material substantially destroys retroreflectivity of the portions of the structured surface that are directly adjacent thereto. Barrier layers are disposed between the adhesive material and the low refractive index layer. The barrier layer has sufficient structural integrity to substantially prevent flow of the adhesive material into the low refractive index layer. Exemplary materials for the barrier layer include resins, polymeric materials, inks, dyes, and vinyls. In some embodiments, the barrier layer traps a low refractive index material in the low refractive index layer. Low refractive index materials are materials that have an index of refraction that is less than 1.3 (e.g., air and low index materials (e.g., low refractive index materials described in U.S. Patent Application Publication No. 2012/0038984 (Patel et al.), which is hereby incorporated herein in its entirety). In some embodiments, the adhesive material is a pressure sensitive adhesive. In some embodiments, the retroreflective article includes a pressure sensitive adhesive layer that contacts at least some of the discrete truncated cube corner elements. The pressure sensitive adhesive layer comprises at least one discrete barrier layer. In some embodiments, the pressure sensitive adhesive comprises a plurality of discrete barrier layers. In other embodiments, the adhesive material is a hot-melt adhesive.

Regardless of which method and/or constructions are used to make the retroreflective articles, the articles of the present application have certain unique optical features. One way of measuring these unique optical features of the retroreflective articles of the present application involves measuring the coefficient of retroreflection (also referred to herein as retroreflectivity or brightness), R_{A}, which can be measured according to US Federal Test Method Standard 370 at −4° entrance, 0° orientation, and at various observation angles. R_{A} is typically measured at discrete observation angles and averaged over the annular region between two adjacent measured observation angles.

Another way of measuring these unique optical features is measuring total light return (TLR) or fractional retroreflectance R_{T} of the retroreflective article. R_{T}, which is explained in detail in ASTM E808-01, is the fraction of unidirectional flux illuminating a retroreflector that is received at observation angles less than a designated maximum value, αₘₐₓ. Thus, R_{T} represents the portion of light being returned within a prescribed maximum observation angle, αₘₐₓ. In a manner consistent with ASTM E808-01, R_{T} can be calculated as follows:

$${R}_{T} = {\int }_{α = 0}^{{α}_{max}} {\int }_{γ = - π}^{π} ( \frac{{R}_{c}}{cos ( β )} ) ( α ) d γ d α ,$$

where α is the observation angle (expressed in radians), γ is the presentation angle (also expressed in radians), β is the entrance angle, and R_{A} is the conventional coefficient of retroreflection expressed in units of candelas per lux per square meter. For purposes of this application, R_{T} refers to the fractional retroreflectance expressed as a decimal, and % R_{T} refers to the fractional retroreflectance expressed as a percentage, i.e % R_{T}=R_{T}×100%. In either case, the fractional retroreflectance or TLR is unitless.

Another useful parameter for characterizing retroreflection is R_{T} Slope, which can be defined as the change in R_{T} for a small change or increment in the maximum observation angle, Δαₘₐₓ. A related parameter, % R_{T} Slope, can be defined as the change in % R_{T} for a small change in maximum observation angle, Δαₘₐₓ. Thus, R_{T} Slope (or % R_{T} Slope) represents the slope or rate of change of the R_{T}−αₘₐₓ curve (or % R_{T}−αₘₐₓ curve). For discrete data points these quantities may be estimated by calculating the difference in R_{T} (or % R_{T}) for two different maximum observation angles αₘₐₓ, and dividing that difference by the increment in maximum observation angle, Δαₘₐₓ, expressed in radians. When Δαₘₐₓ is expressed in radians, R_{T} Slope (or % R_{T} Slope) is the rate of change per radian. Alternatively and as used herein, when Δαₘₐₓ is expressed in degrees, R_{T} Slope (or % R_{T} Slope) is the rate of change per degree in observation angle.

The equation given above for R_{T} involves integrating the coefficient of retroreflection R_{A} and other factors over all presentation angles (γ=−π to +π) and over a range of observation angles (α=0 to αₘₐₓ). When dealing with discrete data points this integration can be performed using R_{A} measured at discrete observation angle αₘₐₓ values (0.1 degrees) separated by increments Δαₘₐₓ.

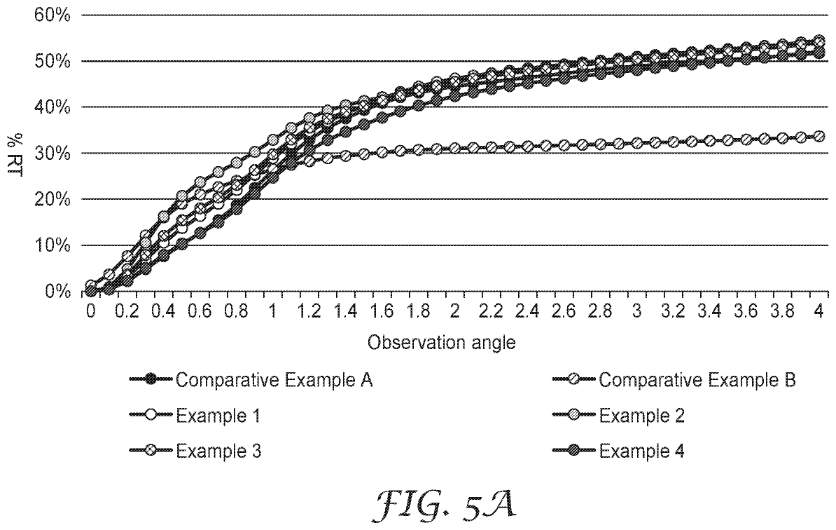

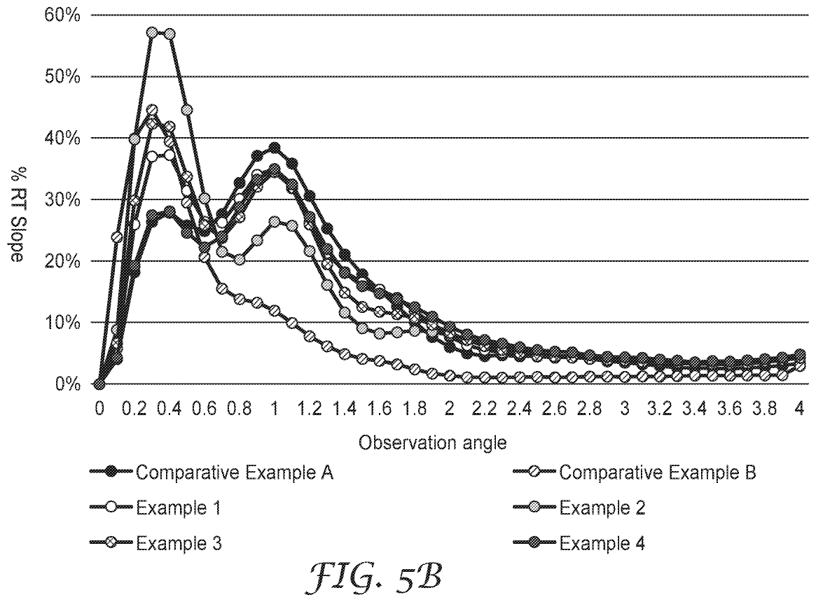

FIGS. 5a and 5b show the retroreflectivity profile, respectively % R_{T} and % R_{T} Slope, of Examples 1-4 and Comparative Examples A-B prepared as described below. In some embodiments, and as seen in FIG. 5a, retroreflective articles having a conformal coating layer and sealing layer according to the present application may increase fractional retroreflectance (R_{T}) over generally all observation angles when compared to conventional retroreflective articles having the same cube corner geometry. As seen in FIG. 5b, in some embodiments, retroreflective articles having conformal coating layer and sealing layer according to the present application may shift light to lower observation angles when compared to conventional retroreflective articles having the same cube corner geometry.

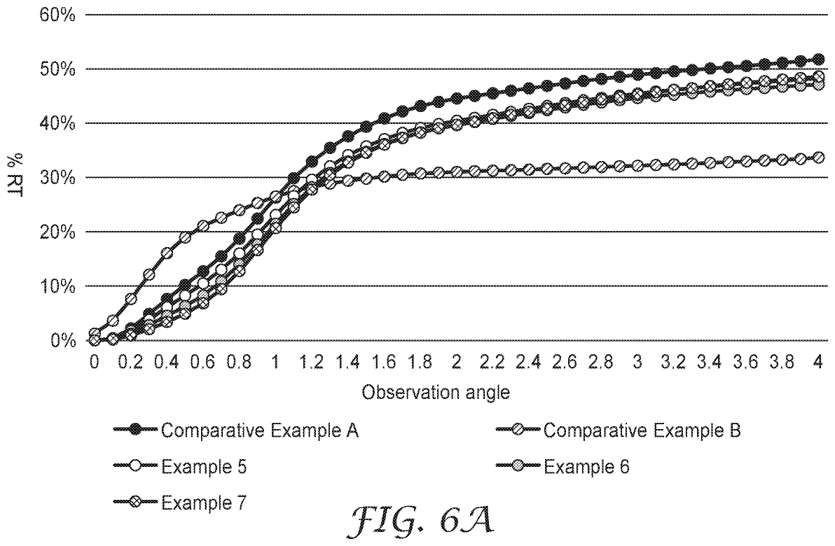

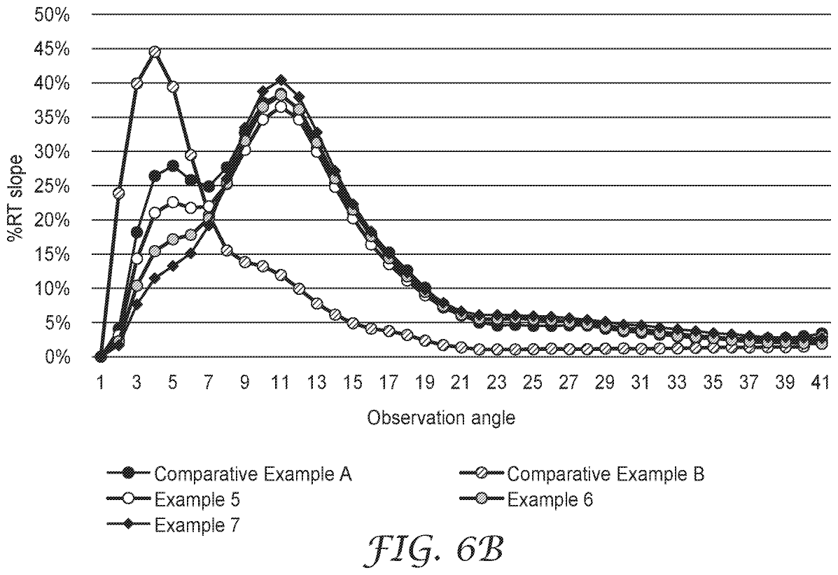

FIGS. 6a and 6b the retroreflectivity profile, respectively % R_{T} and % R_{T} Slope, of Examples 5, 6, and 7 and Comparative Examples A-B prepared as described below. In some embodiments, and as seen in FIG. 6a, fractional retroreflectance (R_{T}) of retroreflective articles according to the present application may be reduced at low observation angles when compared to conventional retroreflective articles having the same cube corner geometry. As seen in FIG. 6b, in some embodiments, retroreflective articles according to the present application may shift light to higher observation angles when compared to conventional retroreflective articles having the same cube corner geometry.

The retroreflective articles of the present disclosure have many uses. Some exemplary uses include highway or street signage articles, license plate sheeting, personal safety devices, personal safety clothing, conspicuity applications, vehicle warning, canvas coatings, security materials and the like. In some embodiments, the retroreflective article is one of a highway signage article, a street signage article, a license plate sheeting, a license plate, a personal safety device, personal safety clothing, a conspicuity article, a vehicle warning article, or a canvas coating article. Where the retroreflective article is used as sheeting, some exemplary substrates to which the retroreflective sheeting can be adhered include, for example, wood, aluminum sheeting, galvanized steel, polymeric materials (e.g., polymethyl methacrylates, polyesters, polyamides, polyvinyl fluorides, polycarbonates, polyvinyl chlorides, polyurethanes), and a wide variety of laminates made from these and other materials.

The retroreflective articles of the present disclosure have various advantages and/or benefits. For example, many embodiments of the retroreflective articles exhibit excellent flexibility. In at least some embodiments, the articles are bendable but not extensible. This flexibility is especially desirable for certain retroreflective sheeting applications, including, for example, barrel wrapping, truck conspicuity, and the like. Additionally, some embodiments of the retroreflective articles of the present disclosure are mechanically durable in terms of their ability to recover from repeated or extended periods of severe distortion and/or distortional flex while, at the same time, are capable of maintaining superior optical properties as defined by efficiency of retroreflection and superior appearance. Also, the retroreflective articles are able to withstand long term exposure to wear and weathering without significant degradation of optical properties or retroreflective brightness. Also, the retroreflective articles have excellent retroreflectivity. Some articles have a brightness of at least 250 candela/lux/m² at an observation angle of 0.2 degree and entrance angle of 4 degrees. Under these conditions, some articles have a brightness of at least 600 candela/lux/m², or at least 1200 candela/lux/m².

Objects and advantages of the retroreflective articles of within the scope of the present application are further illustrated by the following examples, but the particular materials and amounts thereof recited in the examples, as well as other conditions and details, should not be construed to unduly limit the scope of the present application. Unless otherwise noted, all parts, percentages, ratios, etc., in the examples and in the remainder of the specification are by weight.

### EXAMPLES

Materials

| Abbreviation/ | | |
|---|---|---|
| Trade Designation | Material | Supplier |
| PDAC | Poly(diallyldimethyl ammonium chloride), a | Sigma-Aldrich Co., |
| | positively charged polymer with molecular | St. Louis, Missouri |
| | weight 100-200K, obtained as a 20 wt % | |
| | solution in water | |
| SiO₂/NALCO | Silica nanoparticles (20-nm diameter, | Nalco Company, |
| 2327 | ammonium stabilized), obtained as a 40 wt | Naperville, IL |
| | % aqueous dispersion | |
| TiO₂/“TiMaKs- | Anionic anatase titania nanoparticles | Sigma-Aldrich Co. |
| W10.1” | obtained as a 10 wt % suspension in water | |
| TMACl | Tetramethylammonium chloride obtained as | SACHEM, Inc., |
| | a 50% solution in water. | Austin, TX |
| TMAOH | Tetramethylammonium hydroxide obtained | Alfa Aesar, Ward |
| | as a 2.38 wt % solution in water. | Hill, MA |
| EBECRYL 3720 | Bisphenol A epoxy diacrylate | Cytec, Woodland |
| | | Park, New Jersey |
| TMPTA | Trimethylol propane triacrylate | Cytec |
| HDDA | 1,6 hexanediol diacrylate | Cytec |
| LUCIRIN TPO | Photoinitiator | BASF, Florham |
| | | Park, NJ |
| DAROCUR 1173 | Photoinitiator | BASF |
| 14286 PETG | Polyethylene terephthalate glycol pellets | Eastman, Kingsport, |
| | | TN |
| TALH | Titanium (IV) bis(ammonium lactate) | Alfa Aesar |
| | dihydroxide obtained as a 50 wt % solution in | |
| | water | |
| CA-ZrO₂ | Citric acid-modified zirconia nanoparticles, | Prepared as |
| | prepared as a 12 wt % suspension in water | described below |
| PSS | Poly(sodium 4-styrenesulfonate), a | Sigma-Aldrich Co. |
| | negatively charged polymer with molecular | |
| | weight 70K, obtained as a 30 wt % solution | |
| | in water | |
| MELINEX X6715 | Dual-layer construction including a first | DuPont Teijin |
| | layer comprising PET and a second layer, | Films, Chester, VA |
| | adjacent to the first layer, comprising an | |
| | amorphous PET | |

Test Methods

Refractive Index (RI): refractive index was determined using a reflectometer obtained from Filmetrics of San Diego, Calif., under the designation “F10-AR”. Coatings for refractive index measurement were deposited on soda-lime float glass plates (12″×12″×⅛″ thick) procured from Brin Northwestern Glass Company (Minneapolis, Minn.). RI is reported at a wavelength of 632.8 nm. The RI values reported in the Examples correspond to measurements made on identical coatings deposited on glass. For coatings with two or more stacks, RI for the individual stacks is reported based on measurements made on single stack coatings on glass.

Thickness: thickness of conformal coating layers was determined using the F10-AR reflectometer. Coatings for thickness measurement were deposited on soda-lime float glass plates (12″×12″×⅛″ thick) procured from Brin Northwestern Glass Company. Thickness values reported in the Examples correspond to measurements made on identical coatings deposited on glass. In some instances, thickness values were estimated by linear interpolation from a plot of thickness versus number of bi-layers. For coatings with two or more stacks, thickness of individual stacks is reported based on measurements made on single stack coatings on glass.

Coefficient of Retroreflection (brightness) (R_{A}): brightness was measured using a retroreflectometer (Retrosign GR3, commercially available from DELTA Danish Electronics, Light and Acoustics, Denmark) generally using the method described in ASTM E810-03, “Standard Test Method for Coefficient of Retroreflection of Retroreflective Sheeting Utilizing the Coplanar Geometry”. Results are reported in cd/lux·m².

Cap-Y: cap-Y or Luminance factor (Y %) measurements were done following the procedure generally outlined in standard ASTM E 1164, “Standard Practice for Obtaining Spectrometric Data for Object-Color Evaluation”. A HunterLab ColorFlex 45/0 spectrophotometer was used and parameters computed for CIE Illuminant D65 and 2° (two degree) standard observer. A white seal film (prepared as generally described in U.S. Pat. No. 9,366,789, incorporated herein by reference) was laminated to the retroreflective articles of the examples such that the white seal film was adjacent to and in close contact with the cube-corner side of the retroreflective article.

Preparation of Citric Acid-Modified Zirconia

Method for Zirconia Nanoparticle Sol Synthesis and Purification

A zirconia sol was made according to WO 2009/085926 (Kolb et al.) by hydrolyzing an acetic acid zirconium salt at elevated temperature and pressure. The sol was concentrated via distillation to 40.5% ZrO₂ (45% solids) with acetic acid content of about 5-6 mmol per gram of ZrO₂. The disclosure of WO 2009/085926 is incorporated herein by reference in its entirety.

CA-ZrO₂: Zirconia Nanoparticle Surface Modification

ZrO₂ nanoparticles prepared as described above were diluted to 15 wt % with DI water in a volume of 200 mL. A volume of 60 mL of 1 M trisodium citrate dihydrate was added to this suspension with vigorous stirring. The ratio of citrate modifier to ZrO₂ was thus about 2 mmol citrate to 1 gram ZrO₂. This suspension, denoted as CA-ZrO₂, was then dialyzed against a SPECTRAPOR 3500 MWCO (Spectrum Labs, Rancho Dominguez, Calif.) regenerated cellulose dialysis membrane to remove excess citrate and acetic acid. The dialysis bath had a volume of approximately 4 L and was stirred with a magnetic stir bar. The water was replaced with fresh DI water at least five times with at least 2 hour intervals between changes. The resulting CA-ZrO₂ had a concentration of 12% solids.

Preparation of Retroreflective Layer

A retroreflective layer was prepared by casting cube corner elements onto a body layer and subsequently curing the cube corner elements, as generally described in U.S. Pat. No. 7,862,187 (Thakkar et al.), the disclosure of which is incorporated herein by reference in its entirety. A dual-layer body layer comprising a first layer of PET and a second layer of amorphous PET was obtained as a multilayer film from Dupont Teijin Films under the trade designation MELINEX X6715, as generally described in U.S. Patent Application Publication No. 2016/0209558 (Chatterjee et al.), incorporated by reference herein in its entirety.

A cube corner composition was prepared by combining 25 weight percent (wt %) EBECRYL 3720, 50 wt % TMPTA, 25 wt % HDDA. 0.5 parts per hundred weight (pph) LUCIRIN TPO and 0.5 pph DAROCUR 1173. Cube corner elements were formed by casting the cube corner composition into a microstructured tool and subsequently onto the amorphous PET layer of the dual-layer body layer. The cube corner elements were subsequently cured using Fusion D UV lamps operating at 600 W/inch.

Refractive index of the cube corner elements was measured at 1.49.

Preparation of Titanium Dioxide and Silicon Dioxide-Containing Conformal Coating Layers

Conformal coating layers including titanium dioxide (high refractive index layer) or silicon dioxide (low refractive index layer) as polyanions were prepared using an apparatus purchased from Svaya Nanotechnologies, Inc. (Sunnyvale, Calif.) and modeled after the system described in U.S. Pat. No. 8,234,998 (Krogman et al.) as well as Krogman et al., “Automated Process for Improved Uniformity and Versatility of Conformal Deposition”, Langmuir 2007, 23, 3137-3141. The disclosure of both references is included herein by reference in their entirety.

The apparatus comprised pressure vessels loaded with coating solutions and deionized water (DI water). Spray nozzles with a flat spray pattern (from Spraying Systems, Inc., Wheaton, Ill.) were mounted to spray the coating solutions and rinse water at specified times, controlled by solenoid valves. The pressure vessels (Alloy Products Corp., Waukesha, Wis.) containing the coating solutions were pressurized with nitrogen to 30 psi, while the pressure vessel containing DI water was pressurized with air to 30 psi. Flow rates from the coating solution nozzles were each about 10 gallons per hour, while flow rate from the DI water rinse nozzles was about 40 gallons per hour. The retroreflective layer prepared as described above was adhered to a soda lime float glass plate (Brin Northwestern Glass Co.), which was mounted on a vertical translation stage, and held in place with a vacuum chuck. Immediately prior to coating, the cube corner elements of the retroreflective layer were subjected to air corona treatment with a BD-20AC Laboratory Corona Treater (Electro-Technic Products, Chicago, Ill.).

In some embodiments of the present application, a bi-layer refers to the combination of a polycation layer and a polyanion layer. Multiple bi-layers make up a stack. Preparation of a bi-layer is described as follows: a polycation (e.g., PDAC) solution was sprayed onto the retroreflective layer while the stage moved vertically downward at 76 mm/s. Next, after a dwell time of about 12 s, the DI water solution was sprayed onto the retroreflective layer while the stage moved vertically upward at 102 mm/s. Next, after a dwell time of about 4 seconds (s), a polyanion (e.g. SiO₂ or TiO₂) solution was sprayed onto the retroreflective layer while the stage moved vertically downward at 76 mm/s. Finally, after a dwell time of 12 s, the DI water solution was sprayed onto the retroreflective layer while the stage moved vertically upward at 102 mm/s, and a dwell time of 4 s was allowed to elapse. The above sequence was repeated as needed in order to deposit a desired number of bi-layers. Coatings were dried with compressed air or nitrogen following the coating process. The conformal coating layers are generally denoted as (polycation/polyanion)ₙ where “n” is the number of deposited bi-layers.

Coating solutions were prepared as follows. A polycation solution was prepared by further diluting a 20 wt % PDAC in water solution to 20 mM with respect to the repeat unit (i.e., 0.32 wt %). The pH was adjusted to 10.0 with TMAOH. A first polyanion solution was prepared by further diluting a 40.0 wt % SiO₂ nanoparticle solution to 1.0 wt % with DI water. The pH was adjusted to 11.5 with TMAOH, and TMACl was added to a concentration of 48 mM. A second polyanion solution was prepared by further diluting a 10.0 wt % TiO₂ nanoparticle solution to 0.10 wt % with DI water. The pH was adjusted to 11.5 with TMAOH, and TMACl was added to a concentration of 65 mM.

A coating comprising a plurality of bi-layers made of (PDAC/TiO₂)ₙ had a refractive index of about 1.90 at a wavelength of about 633 nm, and a thickness of about 7 nm per bi-layer. Coatings comprising multiple bi-layers of (PDAC/TiO₂)ₙ are hereinafter referred to as “high refractive index coatings” and abbreviated as “H”. Coatings comprising a plurality of bi-layer made of (PDAC/SiO₂)ₙ had a refractive index at 633 nm of approximately 1.27 and a thickness of about 18 nm per bi-layer. Coatings comprising multiple bi-layers of (PDAC/SiO₂)ₙ are hereinafter referred to as “low refractive index coatings” and abbreviated as “L”.

Preparation of Titanium Dioxide-Containing Conformal Coating Layers

Titanium dioxide-containing conformal coating layers were prepared as described above for titanium-dioxide and silicon-dioxide containing conformal coating layers, with the exception that no silicon dioxide was used. Instead, multiple layers of titanium dioxide-containing solutions were alternated with the PDAC polycation solution.

Preparation of Silicon Dioxide-Containing Conformal Coating Layers

Silicon dioxide-containing conformal coating layers were prepared as described above for titanium-dioxide and silicon-dioxide containing conformal coating layers, with the exception that no titanium dioxide was used. Instead, multiple layers of silicon dioxide-containing solutions were alternated with the PDAC polycation solution.

Preparation of Citric Acid-Modified Zirconate-Containing Conformal Coating Layers

Citric acid-modified zirconium dioxide-containing (CA-ZrO₂) conformal coating layers were prepared as described above for titanium-dioxide containing conformal coatings, with the following exceptions: (1) CA-ZrO₂ (instead of titanium dioxide) was used at a concentration of 1.0 wt %; (2) ionic strength was set to 10 mM with NaCl; and (3) pH was set to 10 with NaOH.

Preparation of TALH-Containing Conformal Coating Layers

TALH-containing conformal coating layers were prepared as described above for titanium-dioxide containing conformal coatings, with the following exceptions: (1) TALH (instead of titanium dioxide) was used at a concentration of 1.0 wt %; (2) no salt was added; and (3) no pH adjustment was carried out.

Preparation of PSS-Containing Conformal Coating Layers

PSS-containing conformal coating layers were prepared as described above for titanium-dioxide containing conformal coatings, with the following exceptions: (1) the pH of the PDAC solution was not adjusted; (2) PSS (instead of titanium dioxide) was used at a concentration of 20 mM with respect to the repeat unit; and (3) ionic strength was set to 0.5 M with NaCl for both the PDAC and PSS solutions.

### Comparative Example A

Retroreflective article of Comparative Example A comprised a retroreflective layer prepared as described above. The article had air contacting the cube corner elements (i.e., included an air interface).

### Comparative Example B

Retroreflective article of Comparative Example B was prepared by metallizing the cube corner elements of a retroreflective layer prepared as described above. Aluminum was vapor coated onto the cube corner elements as generally described in U.S. Pat. No. 6,663,246, the disclosure of which is incorporated herein by reference in its entirety. The aluminum layer had a thickness of about 4×10⁻⁶ gm/in² (approximately 800-1000 nm).

### Examples 1-7 and Comparative Examples C-E

Retroreflective articles of Examples 1-7 and Comparative Examples C-E were prepared by disposing conformal coating layers on retroreflective layers prepared as described above. Conformal coating layers used in Examples 1-7 and Comparative Examples C-E comprised either a stack of high refractive index (H) bi-layers or a stack of low refractive index (L) bi-layers, as shown in Table 1, below.

Retroreflective articles of Examples 5, 6 and 7 and, respectively, Comparative Examples C, D and E were provided with substantially identical conformal coating layers. However, Examples 5, 6 and 7 had air contacting the conformal coating layers. In contrast, Comparative Examples C, D and E had a pressure-sensitive adhesive (PSA) applied to the conformal coating layers, simulating a conventional retroreflective article which is applied to a substrate.

Refractive index and thickness of conformal coating layers were measured as described above. Results are also reported in Table 1, below.

TABLE 1

| | Number “n” of | Number “n” of L | Refractive | |
|---|---|---|---|---|
| | H bi-layers of | bi-layers of | Index (RI) | Thickness |
| Examples | (PDAC/TiO₂)ₙ | (PDAC/SiO₂)ₙ | at 633 nm | (nm) |
| Example 1 | 5 | 0 | 1.89 | 33 |
| Example 2 | 10 | 0 | 1.89 | 73 |
| Example 3 | 15 | 0 | 1.89 | 114 |
| Example 4 | 20 | 0 | 1.89 | 155 |
| Example 5 | 0 | 3 | 1.26 | 56 |
| Example 6 | 0 | 6 | 1.26 | 116 |
| Example 7 | 0 | 9 | 1.26 | 176 |
| Comparative | 0 | 3 | 1.26 | 56 |
| Example C | | | | |
| Comparative | 0 | 6 | 1.26 | 116 |
| Example D | | | | |
| Comparative | 0 | 9 | 1.26 | 176 |
| Example E | | | | |

FIGS. 5a and 5b show the retroreflectivity profile, respectively % R_{T} and % R_{T} Slope, of Examples 1-4 and Comparative Examples A-B. Examples 1-4 comprised a stack of high refractive index bi-layers (H). In some embodiments, and as seen in FIG. 5b, retroreflective articles having a conformal coating layer and sealing layer according to the present application may shift light to lower observation angles (e.g., observation angles lower than 1 degree) when compared to conventional retroreflective articles having the same cube corner geometry. Comparative Example B includes a metallic layer and as previously explained, has a lower total light return.

FIGS. 6a and 6b show the retroreflectivity profile, respectively % R_{T} and % R_{T} Slope, of Examples 5, 6, 7 and 15 and Comparative Examples A-B. Examples 5, 6, and 7 comprised a stack of low refractive index bi-layers (L). In some embodiments, and as seen in FIG. 6b, retroreflective articles having a conformal coating layer and sealing layer according to the present application may shift light to higher observation angles (e.g., observation angles higher than 1 degree) when compared to conventional retroreflective articles having the same cube corner geometry.

### Examples 8-13 and Comparative Example F

Retroreflective articles were prepared as described above in Examples 1-7 and Comparative Examples C-E, with the exception that conformal coating layers of Examples 8-13 and Comparative Example F included a plurality of alternating low refractive index stacks (L) and high refractive index stacks (H), as indicated in Table 2, below. The first stack in each conformal coating layer (i.e., adjacent the cube corner elements) was the low refractive index stack (L).

Each low refractive index (L) stack in the conformal coating layers of Examples 8-14 and Comparative Example F comprised a number “n” of low-refractive index bi-layers (PDAC/SiO₂). Similarly, each high refractive index stack (H) comprised a number “n” of high refractive index bi-layers (PDAC/TiO₂).

No pressure sensitive adhesive was coated on conformal coating layers of the retroreflective articles of Examples 8-13. In contrast, a PSA was applied to the conformal coating layer of Comparative Example F.

Total thickness of conformal coating layers were measured as described above. Results are also reported in Table 2, below.

TABLE 2

| | Configuration | Number “n” of | |
|---|---|---|---|
| | of conformal | alternating bi-layers per stack | Thickness |
| Examples | coating layer | (PDAC/SiO₂)ₙ/(PDAC/TiO₂)ₙ | (nm) |
| Example 8 | LH | 5/8 | 146 |
| Example 9 | LH | 7/7 | 210 |
| Example 10 | LH | 6/10 | 178 |
| Example 11 | LHLH | 6/10/6/10 | 356 |
| Example 12 | LHLHLH | 6/10/6/10/6/10 | 534 |
| Example 13 | LHLHLHLH | 6/10/6/10/6/10/6/10 | 712 |
| Example 14 | LH | 6/10 | 189 |
| Comparative | LH | 6/10 | 189 |
| Example F | | | |

### Examples 15-16

Retroreflective articles were prepared as described above in Examples 8-13 and Comparative Example F, with the exception that the first stack in each conformal coating layer was the high refractive index stack (H).

TABLE 3

| | | Number “n” of | |
|---|---|---|---|
| | | alternating bi-layers | |
| | Configuration of | (PDAC/TiO₂)ₙ/ | |
| | conformal coating | (PDAC/SiO₂)ₙ/ | |
| Examples | layer | (PDAC/TiO₂)ₙ | Thickness (nm) |
| Example 15 | HL | 10/6/0 | 178 |
| Example 16 | HLH | 10/6/10 | 248 |

### Examples 17-20

Examples 17-20 were prepared as described above for Examples 1-7 and Comparative Examples C-E, except that a CA-ZrO₂-containing conformal coating layer was provided. The CA-ZrO₂ solution used was prepared as described above. Details are shown in Table 4, below, where “est” is used when thickness was estimated.

TABLE 4

| | Number “n” of alternating | Thickness | Refractive Index |
|---|---|---|---|
| Examples | bi-layers (PDAC/Ca-ZrO₂)ₙ | (nm) | at 633 nm |
| Example 17 | 5 | 28 (est) | 1.71 |
| Example 18 | 10 | 87 | 1.71 |
| Example 19 | 15 | 146 (est) | 1.71 |
| Example 20 | 20 | 206 | 1.71 |

### Examples 21-24

Examples 21-24 were prepared as described above for Examples 17-20 except that a TALH-containing conformal coating layer was provided. The TALH-containing solution used was prepared as described above. Details are shown in Table 5, below.

TABLE 5

| | Number “n” of alternating | Thickness | Refractive Index |
|---|---|---|---|
| Examples | bi-layers (PDAC/TALH)ₙ | (nm) | at 633 nm |
| Example 21 | 5 | 10 (est) | 1.78 |
| Example 22 | 10 | 44 | 1.78 |
| Example 23 | 15 | 91 (est) | 1.78 |
| Example 24 | 20 | 139 | 1.78 |

### Examples 25-28

Examples 25-28 were prepared as described above for Examples 17-20 except that a PSS-containing conformal coating layer was provided. The PSS-containing solution used was prepared as described above. Details are shown in Table 6, below.

TABLE 6

| | Number “n” of alternating | Thickness | Refractive Index |
|---|---|---|---|
| Examples | bi-layers (PDAC/PSS)ₙ | (nm) | at 633 nm |
| Example 25 | 5 | 18 (est) | 1.55 |
| Example 26 | 10 | 71 | 1.55 |
| Example 27 | 15 | 124 (est) | 1.55 |
| Example 28 | 20 | 177 | 1.55 |

Retroreflectivity (R_{A}) of the Comparative Examples A-E and Examples 1-28 at various entrance and observation angles was measured according to the test method described above. Table 7 shows retroreflectivity measured (R_{A}) at an observation angle of 0.2 degree and varying entrance angles. Results are reported as an average value of R_{A} measured at 0 and 90 orientation angles for a specific entrance angle, and N/M indicates “not measured”.

TABLE 7

| | R_{A} at 0.2 observation angle (cd/lux · m²) | | | | |
|---|---|---|---|---|---|
| | Entrance Angle (degrees) | | | | |
| | 4 | 15 | 30 | 45 | 60 |
| Comparative Example A | 661 | 535 | 136 | 22 | 0 |
| Comparative Example B | 1033 | 852 | 444 | 131 | 24 |
| Comparative Example C | 0 | N/M | N/M | N/M | N/M |
| Comparative Example D | 0 | N/M | N/M | N/M | N/M |
| Comparative Example E | 0 | N/M | N/M | N/M | N/M |
| Comparative Example F | 0 | N/M | N/M | N/M | N/M |
| Example 1 | 888 | 640 | 110 | 23 | 4 |
| Example 2 | 1407 | 1047 | 188 | 37 | 4 |
| Example 3 | 1024 | 701 | 129 | 26 | 9 |
| Example 4 | 656 | 421 | 87 | 17 | 3 |
| Example 5 | 523 | N/M | N/M | N/M | N/M |
| Example 6 | 380 | N/M | N/M | N/M | N/M |
| Example 7 | 273 | N/M | N/M | N/M | N/M |
| Example 8 | 1391 | 1154 | 296 | 65 | 11 |
| Example 9 | 937 | 725 | 201 | 49 | 6 |
| Example 10 | 997 | 803 | 203 | 43 | 6 |
| Example 11 | 469 | 420 | 133 | 47 | 7 |
| Example 12 | 212 | 164 | 74 | 26 | 3 |
| Example 13 | 282 | 222 | 66 | 18 | 5 |
| Example 14 | 1129 | N/M | N/M | N/M | N/M |
| Example 15 | 1060 | 657 | 127 | 21 | 2 |
| Example 16 | 797 | 673 | 203 | 53 | 9 |
| Example 17 | 840 | 701 | 258 | 54 | 2 |
| Example 18 | 1258 | 1022 | 352 | 74 | 3 |
| Example 19 | 1075 | 842 | 204 | 38 | 2 |
| Example 20 | 721 | 612 | 197 | 39 | 87 |
| Example 21 | 752 | 626 | 164 | 32 | 8 |
| Example 22 | 1275 | 1030 | 238 | 50 | 16 |
| Example 23 | 1382 | 1084 | 250 | 47 | 6 |
| Example 24 | 1200 | 931 | 221 | 45 | 9 |
| Example 25 | 653 | 536 | 138 | 29 | 2 |
| Example 26 | 661 | 548 | 145 | 30 | 2 |
| Example 27 | 648 | 518 | 128 | 23 | 9 |
| Example 28 | 574 | 468 | 116 | 24 | 8 |

Retroreflective articles of Examples 5, 6 and 7 and, respectively, Comparative Examples C, D and E were provided with substantially identical conformal coating layers. Examples 5, 6 and 7 had air contacting their respective conformal coating layers while Comparative Examples C, D and E had a PSA disposed on their respective conformal coating layers. As it may be seen by the results shown in Table 7, the conformal coatings described in the present application may not be used simply to replace conventional seal films and/or metallic layers. The present inventors surprisingly found that these conformal coating layer may be used in conjunction with conventional sealing films to impart changes to the retroreflective performance of retroreflective articles.

Table 8 shows retroreflectivity measured (R_{A}) at an entrance angle of 4 degrees and varying observation angles. Results are reported as an average value of R_{A} measured at 0 and 90 orientation angles for a specific observation angle. Cap-Y was also measured using the test method described above. Results are reported in Table 8, below.

TABLE 8

| | R_{A} at 4 degrees | | | |
|---|---|---|---|---|
| | entrance angle (cd/lux · m²) | | | |
| | Observation Angle (degrees) | | | |
| | 0.2 | 0.5 | 1.0 | cap-Y |
| Comparative Example A | 596.5 | 233.5 | 153.5 | 43.37 |
| Comparative Example B | 881.5 | 267.5 | 63.5 | 14.41 |
| Comparative Example F | 6.5 | 3.5 | 2.5 | N/M |
| Example 1 | 863.5 | 267.5 | 152.0 | 43.26 |
| Example 2 | 1319.5 | 330.5 | 123.0 | 44.61 |
| Example 3 | 925.0 | 257.0 | 151.0 | 46.22 |
| Example 4 | 570.0 | 205.0 | 151.0 | 47.72 |
| Example 5 | 523.5 | 218.0 | 161.5 | N/M |
| Example 6 | 380.0 | 190.0 | 163.0 | N/M |
| Example 7 | 273.0 | 169.0 | 165.5 | N/M |
| Example 8 | 1264.5 | 368.5 | 70.5 | 44.04 |
| Example 9 | 845.0 | 307.0 | 64.0 | 45.17 |
| Example 10 | 959.5 | 357.0 | 50.5 | 44.76 |
| Example 11 | 561.0 | 205.0 | 34.5 | 48.76 |
| Example 12 | 180.5 | 82.5 | 39.5 | 52.45 |
| Example 13 | 279.5 | 153.0 | 33.5 | N/M |
| Example 14 | 1129.0 | 392.5 | 120.5 | N/M |
| Example 15 | 918.5 | 259.0 | 136.0 | 45.2 |
| Example 16 | 755.5 | 260.5 | 43.0 | 48.06 |
| Example 17 | 694.0 | 243.5 | 148.0 | 43.76 |
| Example 18 | 1090.0 | 318.0 | 134.5 | 44.09 |
| Example 19 | 930.0 | 282.0 | 141.0 | 40.29 |
| Example 20 | 642.5 | 232.5 | 142.0 | N/M |
| Example 21 | 665.5 | 247.0 | 151.0 | 44.04 |
| Example 22 | 581.0 | 231.0 | 150.0 | N/M |
| Example 23 | 1275.5 | 324.5 | 127.0 | 44.21 |
| Example 24 | 1132.5 | 307.5 | 131.0 | 44.88 |
| Example 25 | 581.0 | 231.0 | 150.0 | 42.73 |
| Example 26 | 576.0 | 229.5 | 150.0 | 43.28 |
| Example 27 | 564.5 | 229.5 | 149.5 | 42.88 |
| Example 28 | 479.5 | 207.0 | 143.5 | 44.08 |

Those having skill in the art will appreciate that many changes may be made to the details of the above-described embodiments and implementations without departing from the underlying principles thereof. The scope of the present disclosure should, therefore, be determined only by the following claims.

1. A retroreflective article comprising:
a retroreflective layer including a plurality of cube corner elements that collectively form a structured surface that is opposite a major surface;
a conformal coating layer adjacent to the structured surface;
a sealing layer adjacent to the conformal coating layer; and
a low refractive index layer between the sealing layer and the conformal coating layer.

2. The retroreflective article of claim 1, wherein the conformal coating layer includes a stack comprising at least one bi-layer.

3. The retroreflective article of claim 2, wherein the bi-layer includes a first material and a second material.

4. The retroreflective article of claim 3, wherein the first material includes a first bonding group and the second material includes a second bonding group.

5. (canceled)

6. The retroreflective article of claim 3, wherein the first material includes a polyelectrolyte and the second material includes nanoparticles.

7. The retroreflective article of claim 3, wherein the first material includes a polycation and the second material includes a polyanion.

8. The retroreflective article of claim 7, wherein the polycation is selected from the group consisting of polydiallydimethylammonium chloride, polyethyleneimine, polyallylamine, poly(2-(trimethylamino)ethyl methacrylate, and copolymers thereof.

9. (canceled)

10. The retroreflective article of claim 3, wherein one of the first material or the second material includes elements selected from the group consisting of zirconium, silicon and titanium.

11. The retroreflective article of claim 1, wherein the cube corner elements have a first refractive index and the conformal coating layer has a second refractive index, wherein the second refractive index is greater than the first refractive index.

12. The retroreflective article of claim 1, wherein the conformal coating layer has a refractive index between about 1.6 and about 2.4.

13. (canceled)

14. The retroreflective article of claim 1, wherein the conformal coating layer has a thickness between about 10 nm and about 250 nm.

15. (canceled)

16. The retroreflective article of claim 3, wherein the first material is a polycation and the first material contacts the cube corner elements.

17. The retroreflective article of claim 1, wherein the sealing layer further includes a first region in contact with the conformal coating layer and a second region, and wherein the first region surrounds the second region.

18. The retroreflective article of claim 17, wherein the second region of the sealing layer includes at least one barrier layer.

19. The retroreflective article of claim 1, wherein the low refractive index layer includes one of a low refractive index material and air.

20. The retroreflective article of claim 1, wherein the sealing layer comprises one of a pressure sensitive adhesive or a hot-melt adhesive.

21. The retroreflective article of claim 1, wherein the first region is raised relative to the second region.

22. The retroreflective article of claim 1, wherein the second region corresponds to a cell having a cell size.

23. The retroreflective article of claim 22, wherein the cell size is less than 1000 microns.

24. A retroreflective article comprising:
a retroreflective layer including a plurality of cube corner elements that collectively form a structured surface that is opposite a major surface;
a conformal coating layer adjacent to the structured surface, the conformal coating layer comprising at least one bi-layer, wherein the bi-layer includes a first layer in planar contact with at least a portion of the structured surface and a second layer adjacent the first layer;
a sealing layer having a first region and a second region, wherein the first region is in contact with a portion of the first layer of the conformal coating layer and surrounds the second region; and
a low refractive index layer between the second region and the structured surface.

25-39. (canceled)
